(19) United States
(12) Patent Application Publication
(10) Pub. No.: US 2023/0288829 A1
(43) Pub. Date: Sep. 14, 2023

(54) RESIN PARTICLES, TONER, DEVELOPER, TONER HOUSING UNIT, IMAGE FORMING APPARATUS, AND METHOD OF FORMING IMAGE

(71) Applicants: Kazuoki FUWA, Shizuoka (JP); Yuka MIZOGUCHI, Shizuoka (JP); Junichi WATANABE, Shizuoka (JP); Toshihiko SUGIYAMA, Shizuoka (JP); Natsuko MATSUSHITA, Shizuoka (JP)

(72) Inventors: Kazuoki FUWA, Shizuoka (JP); Yuka MIZOGUCHI, Shizuoka (JP); Junichi WATANABE, Shizuoka (JP); Toshihiko SUGIYAMA, Shizuoka (JP); Natsuko MATSUSHITA, Shizuoka (JP)

(21) Appl. No.: 18/115,779

(22) Filed: Mar. 1, 2023

(30) Foreign Application Priority Data
Mar. 11, 2022 (JP) 2022-038542
Dec. 15, 2022 (JP) 2022-200071

(51) Int. Cl. G03G 9/09; G03G 9/087; G03G 15/08

(52) U.S. Cl. CPC G03G 9/0906; G03G 9/08755; G03G 9/08782; G03G 15/0865

(57) ABSTRACT

[Summary] To provide resin particles with high weather resistance even when a plant-derived resin and PET are used as binder resins.

[Tasks] The Resin particles includes a binder resin and a colorant, wherein the binder resin contains polyethylene terephthalate and a plant-derived resin, wherein the colorant contains an isoindoline pigment, and wherein a radioisotope ¹⁴C concentration in the resin particles is 5.4 pMC or higher.

### CROSS-REFERENCE TO RELATED APPLICATION

The present application claims priority under 35 U.S.C. § 119 to Japanese Patent Application No. 2022-038542, filed Mar. 11, 2022 and No. 2022-200071, filed Dec. 15, 2022, the contents of which are incorporated herein by reference in their entirety.

### BACKGROUND OF THE INVENTION

### 1. Field of the Invention

The disclosures herein relate to resin particles, a toner, a developer, a toner housing unit, an image forming apparatus, and a method of forming images.

### 2. Description of the Related Art

Resin particles are widely used as toner of image forming apparatus such as multi-functional printers (MFP) and printers in various places such as offices. In order to reduce the impact on the environment, the following are being considered for toner: reducing power consumption by improving the low-temperature fixability of the toner itself, reducing energy consumption during manufacturing, using biomass (plant)-derived resins for binder resins, and using recycled raw materials for binder resins. In particular, since plant-derived resins tend to deteriorate the durability of resin particles, it is necessary to avoid using large amounts of plant-derived resins as binder resins from the perspective of heat-resistant storage stability of the resin particles.

As a toner containing a binder resin produced using plant-derived resin, there is a method of combining a plant-derived resin with, for example, PET, which is easily available as a recycled product and has high durability. For example, technology has been disclosed to provide a sustainable toner by using approximately 70% of the total amount of bio-based and recycled PET in the resin as a binder resin (See, e.g., Japanese Patent Laid-Open No. 2014-098149).

### SUMMARY OF THE INVENTION

### Problems to be Solved by Invention

However, as in the technology disclosed in Japanese Patent Laid-Open No. 2014-098149, when a plant-derived resin and PET resin are used together, there is a problem that the strength is reduced by the plant-derived resin, and furthermore, the brittleness of the resin by PET causes minute cracks and the weather resistance is significantly reduced.

One aspect of the present invention is to provide resin particles with high weather resistance even when a plant-derived resin and PET are used as a binder resin.

### Means to Solve Problems

One aspect of the resin particles according to the present invention is to provide resin particles including a binder resin and a colorant, wherein the binder resin contains polyethylene terephthalate and a plant-derived resin, wherein the colorant contains an isoindoline pigment, and wherein a radioisotope ¹⁴C concentration in the resin particles is 5.4 pMC or higher.

### Effect of Invention

One aspect of the invention can provide resin particles with high weather resistance even when plant-derived resin and PET are used as binder resins.

### BRIEF DESCRIPTION OF THE DRAWINGS

FIG. 1 is a schematic diagram illustrating an example of an image forming apparatus according to an embodiment;

FIG. 2 is a schematic diagram illustrating another example of an image forming apparatus according to an embodiment;

FIG. 3 is a schematic diagram illustrating an example of an image forming apparatus according to an embodiment;

FIG. 4 is a partially enlarged view of the image forming apparatus of FIG. 3; and

FIG. 5 is a schematic diagram illustrating an example of a process cartridge according to an embodiment.

### DESCRIPTION OF THE PREFERRED EMBODIMENTS

Embodiments of the present invention will be described in detail below. Embodiments are not limited by the following descriptions, and may be appropriately changed to the extent that the changes do not deviate from the gist of the invention. In addition, “to” denoting a numerical range in the specification means, unless otherwise stated, that the numerical values listed before and after the number are included as lower and upper limits.

<Resin Particles>

The resin particles according to one embodiment will be described. The resin particles according to one embodiment contain a binder resin and a colorant, and may contain other components as needed.

(Concentration of Radioisotope ¹⁴C)

A concentration of radioisotope ¹⁴C (hereinafter sometimes referred to as “¹⁴C concentration”) of the resin particles according to one embodiment is 5.4 pMC or higher, preferably 10 pMC or higher, more preferably 13 pMC or higher, and even more preferably 15 pMC or higher. The concentration of radioisotope ¹⁴C is preferably 70 pMC or lower. When the concentration of the radioisotope ¹⁴C in the resin particles is 5.4 pMC or higher, a biomass degree does not tend to be recognized as a low biomass degree, and a reduction of impact on the environment can be achieved. When the radioisotope ¹⁴C concentration in the resin particles is 70 pMC or lower, the strength of toner can be maintained.

Here, “pMC” stands for percent Modern Carbon and defines a unit represents ¹⁴C concentration. When the ¹⁴C concentration of the standard sample in the year 1950 is taken as 100%, the ¹⁴C concentration of the unknown sample is represented as a percentage as a ratio to the standard sample. The ¹⁴C concentration in the current atmosphere is increasing year by year. Therefore, it is prescribed to multiply the value by a factor for correction. An appropriate correction factor for the year is used for the correction.

The ¹⁴C concentration is represented as the degree of biomass calculated by the following formula (1).

Degree of Biomass (%)=¹⁴C concentration (pMC)×0.935 (1)

A ¹⁴C concentration of 5.4 pMC or higher means that the degree of biomass is 5% or higher. This is the concentration required from a carbon-neutral perspective. The ¹⁴C concentration is more preferably 20% or higher and even more preferably 40% or higher.

The ¹⁴C concentration defines how much carbon is plant-derived carbon in the elemental carbon component of petrochemical products containing carbon. The ¹⁴C concentration in the elemental carbon of petrochemical products can be measured according to ASTM-D6866, the American Society for Testing and Materials ASTM standard, for example.

The ¹⁴C is present in the natural world (in the atmosphere), and is taken up by photosynthesis during plant activity. The ¹⁴C concentration in the CO₂ in the atmosphere and the ¹⁴C concentration taken up by plants are in equilibrium (107.5 pMC). However, the ¹⁴C taken by photosynthesis stops from the stage when organisms cease their life activity, and the ¹⁴C concentration halves every 5,730 years, which is the half-life of ¹⁴C. Since fossil resources from living sources are tens of thousands to hundreds of millions of years from the cessation of life, ¹⁴C concentration is rarely detected.

One way to increase the ¹⁴C concentration in resin particles is to use plant-derived materials as binder resins, crystalline resins, and release agents.

[Binder Resin]

The binder resin used in the present embodiment includes at least one amorphous resin, polyethylene terephthalate (PET), and a plant (biomass)-derived resin.

(Amorphous Resin)

As the amorphous resin, terpene resin and amorphous polyester resin are preferably used, and the amorphous polyester resin, which is advantageous for low-temperature fixability, is more preferably used. Among the amorphous polyester resins, linear polyester resin is preferably used. Among the linear polyester resins, unmodified polyester resin is preferably used.

An unmodified polyester resin is a polyester resin obtained by using a polyvalent alcohol and a polyvalent carboxylic acid such as a polyvalent carboxylic acid, a polyvalent carboxylic anhydride, and a polyvalent carboxylic ester or its derivative, and is a polyester resin which is not modified by an isocyanate compound or the like.

The amorphous polyester resin preferably has neither a urethane bond nor a urea bond.

The amorphous polyester resin is obtained using a polyvalent alcohol and a polyvalent carboxylic acid.

Examples of the polyvalent alcohol include diols and the like.

Examples of diols include alkylene (having 2 to 3 carbons) oxide (average additive mole number of 1 to 10) adducts of bisphenol A such as polyoxypropylene (2.2)-2,2-bis(4-hydroxyphenyl) propane, polyoxyethylene (2.2)-2,2-bis(4-hydroxyphenyl) propane, and the like; ethylene glycol, and propylene glycol; hydrogenated bisphenol A, alkylene (having 2 to 3 carbons) oxide (average additive molar number of 1 to 10) adducts of hydrogenated bisphenol A; and the like. These may be used alone or in a combination of two or more. Among these, plant-derived ethylene glycol and propylene glycol are preferably used.

Examples of the polyvalent carboxylic acid include dicarboxylic acid and the like.

Examples of dicarboxylic acids include adipic acid, phthalic acid, isophthalic acid, terephthalic acid, fumaric acid, and maleic acid; succinic acid substituted with an alkyl group having 1 to 20 carbons such as dodecenylsuccinic acid, octylsuccinic acid, and the like or an alkenyl group having 2 to 20 carbons, modified purified rosin, and the like. These may be used alone or in combination of two or more.

The modified purified rosin is preferably modified with acrylic acid, fumaric acid, and maleic acid. These may be used alone or in combination of two or more.

When an amorphous polyester resin contains a dicarboxylic acid component as a constituent, the amorphous polyester resin preferably contains 50 mol % or more of terephthalic acid as a dicarboxylic acid component. This improves the heat-resistant storage stability of the resin particles.

Among these, plant-derived saturated aliphatic succinic acid, modified purified rosin, and the like are preferably used. Plant-derived acid or rosin can increase carbon neutrality. Saturated aliphatic resins have the effect of increasing the recrystallization properties of crystalline polyester resins, thus increasing the aspect ratio of crystalline polyester resins and improving low-temperature fixability.

In addition, for the purpose of adjusting the acid value and the hydroxyl value, the amorphous polyester resin may contain at least one of trivalent or higher carboxylic acid and trivalent or higher alcohol at the end of the resin chain.

Examples of the trivalent or higher carboxylic acids include trimellitic acid, pyromellitic acid, their anhydrides, or the like.

Examples of the trivalent or higher alcohols include glycerin, pentaerythritol, trimethylolpropane, or the like.

The molecular weight of the amorphous polyester resin is not particularly limited, and can be appropriately selected according to the purpose. In gel permeation chromatography (GPC) measurements, the weight-average molecular weight (Mw) is preferably in a range from 3,000 to 10,000. The number-average molecular weight (Mn) is preferably in a range from 1,000 to 4,000. The ratio of weight-average molecular weight (Mw) to number-average molecular weight (Mn), Mw/Mn, is preferably in a range from 1.0 to 4.0. When the molecular weight is the lower limit value or more, the heat-resistant storage of the toners and the durability against stress such as stirring in the developer can be suppressed. When the molecular weight is the upper limit value or less, the increase in viscoelasticity of the resin particles during melting can be suppressed and the decrease in low-temperature fixability can be suppressed.

The weight-average molecular weight (Mw) is more preferably in a range from 4,000 to 7,000. The number-average molecular weight (Mn) is more preferably in a range from 1,500 to 3,000. The ratio of weight-average molecular weight (Mw) to number-average molecular weight (Mn), Mw/Mn, is more preferably in a range from 1.0 to 3.5.

The acid value of the amorphous polyester resin is not particularly limited, and can be appropriately selected according to the purpose. The acid value of the amorphous polyester resin is preferably in a range from 1 mgKOH/g to 50 mgKOH/g, and more preferably in a range from 5 mgKOH/g to 30 mgKOH/g. When the acid value is 1 mgKOH/g or more, the toners tend to become negatively charged, and furthermore, the affinity between paper and the toners at the time of fixing to the paper improves the low-temperature fixability. When the acid value is 50 mgKOH/g or less, the decrease in the chargeability stability, especially the decrease in the chargeability stability against environmental fluctuations, can be suppressed.

The hydroxyl value of the amorphous polyester resin is not particularly limited and can be appropriately selected according to the purpose. The hydroxyl value of the amorphous polyester resin is preferably 5 mgKOH/g or more.

The glass transition temperature (Tg) of the amorphous polyester resin is preferably in a range from 40° C. to 80° C., and more preferably in a range from 50° C. to 70° C. When the glass transition temperature (Tg) is 40° C. or higher, the heat-resistant storage of toners and the durability against stress such as agitation in the developer become sufficient, and the filming resistance also become favorable. When the glass transition temperature (Tg) is 80° C. or lower, the toners are sufficiently deformed by heating and pressurization during the fixing step, and the low-temperature fixability becomes favorable.

The molecular structure of amorphous polyester resins can be confirmed by NMR measurement in solution or in solid state, as well as X-ray diffraction, GC/MS, LC/MS, IR measurement, and the like. A simple method is to detect, as an amorphous polyester resin, those having no absorption at 965±10 cm⁻¹ and 990±10 cm⁻¹ based on the δCH (out-of-plane bending vibration) of olefins in the infrared absorption spectrum.

(PET)

As PET, it is preferable to use recycled PET to reduce environmental impact. There are no particular restrictions on the molecular weight distribution, composition, manufacturing method, and morphology of PET when used. Off-spec fiber scraps and pellets can also be used. The environmental responsiveness ratio and toner quality can be adjusted by adjusting the ratio at which recycled PET is introduced during the synthesis of amorphous polyester resin.

((Method of Calculating and Analyzing the Amount of PET Contained))

The amount of PET contained in a binder resin may be calculated using any method. As a method of analyzing and calculating the content of PET, for example, by separating the components contained in a binder resin from resin particles by gel permeation chromatography (GPC) or the like, and using the analysis method described later for each separated component, the mass ratio of the components can be calculated.

In addition, by using gas chromatography-mass spectrometry (GC/MS) at 300° C. with a reaction reagent (10% tetramethylammonium hydroxide (TMAH)/methanol solution), the main components can be estimated from the soft decomposition of the ester bond in the resin particles by methylation, and each component contained in the binder resin can be quantitatively analyzed by drawing a calibration curve of the total ion current chromatogram (TICC) intensity.

The separation of each component by GPC can be performed, for example, by the following method.

In the GPC measurement using tetrahydrofuran (THF) as a mobile phase, the eluate is separated by a fraction collector or the like, and the fractions corresponding to the desired molecular weight part of the total integration of the elution curve are summarized.

After the collected eluate is concentrated and dried by an evaporator or the like, the solid content is dissolved in a heavy solvent such as heavy chloroform or heavy THF, and ¹H-NMR measurement is performed, and the constituent monomer ratio of the binder resin in the eluate is calculated from the integration ratio of each element.

As another method, the eluate is concentrated, followed by hydrolyzing the eluate with sodium hydroxide or the like, and the constituent monomer ratio of the binder resin is calculated by performing qualitative and quantitative analysis of the degradation product by high-performance liquid chromatography (HPLC) or the like.

The content of PET is not particularly limited and can be selected as appropriate according to the purpose. The content is preferably in a range from parts by mass to 70 parts by mass and more preferably in a range from 10 parts by mass to 50 parts by mass, with respect to 100 parts by mass of resin particles. If the content of PET is 70 parts by mass or less with respect to 100 parts by mass of the resin particles, low-temperature fixability can be achieved. If the content of PET is 5 parts by mass or more with respect to 100 parts by mass of the resin particles, environmental load can be reduced. If the content of PET is in the above more preferable range, it is advantageous in that both the low-temperature fixability of the resin particles and the reduction of environmental load are achieved.

An example of a device for separating each component such as PET contained in resin particles when analyzing the resin particles of one embodiment is explained in detail. First, 1 g of resin particles is put into 100 mL of THF, and a solvent in which the soluble component is dissolved is obtained under the conditions of 25° C. while stirring for 30 minutes. The solvent is filtered through a membrane filter with an opening eye of 0.2 μm to obtain the soluble component of THF in the resin particles. This is then dissolved in THF to make a sample for GPC measurement, and injected into the GPC used to measure the molecular weight of each resin mentioned above. On the other hand, a fraction collector is placed at the effluent outlet of the GPC to separate the eluate at every predetermined count, and the eluate is obtained at every 5% area ratio from the start of elution of the elution curve (the rise of the curve). Then, for each elution, 30 mg of the sample is dissolved in 1 mL of heavy chloroform, and 0.05% by volume of tetramethylsilane (TMS) is added to each elution as the reference material. The solution is filled into a 5 mm diameter glass tube for NMR measurement, and the spectrum is obtained by performing the integration for 128 times using a nuclear magnetic resonance apparatus (JNM-AL400, manufactured by JEOL Ltd.) at a temperature of 23° C. to 25° C. The monomer composition and composition ratio of PET resin or the like contained in the resin particles can be obtained from the peak integration ratio of the obtained spectrum.

(Plant (Biomass)-Derived Resins)

The resin particles in one embodiment contain a biomass-derived resin. The biomass-derived resin may be contained in an amorphous resin contained in the binder resin and in at least one of the crystalline and amorphous resins described below.

The biomass-derived resin is a resin containing plant-derived compounds as raw materials. The biomass-derived resin may be contained in the crystalline resin described below, in the amorphous resin, or in other components such as mold release agents. The resin particles can adjust the environmental responsiveness ratio described below and the toner quality when the resin particles are applied to the toner by adjusting the ratio between the petroleum-derived component and the plant-derived component of the alcohol and acid components constituting the resin particles.

(Crystalline Resin)

In order to improve low-temperature fixability, the toner in one embodiment preferably contains a crystalline resin.

As for the crystalline resin, there is no particular limitations as long as the crystalline resin has crystallinity, and the crystalline resin can be selected appropriately according to the purpose. Examples of the crystalline resins include polyester resins, polyurethane resins, polyurea resins, polyamide resins, polyether resins, vinyl resins, modified crystalline resins, and the like. These may be used alone or in combination of two or more.

(Crystalline Polyester Resin)

The crystalline polyester resin is described below.

The crystalline polyester resin is obtained from a polyvalent alcohol and a polyvalent carboxylic acid component such as a polyvalent carboxylic acid, a polyvalent carboxylic anhydride, a polyvalent carboxylic ester, or a derivative thereof.

In the present embodiment, the crystalline polyester resin is defined as one obtained by using a polyvalent alcohol and a polyvalent carboxylic acid such as a polyvalent carboxylic acid, a polyvalent carboxylic anhydride, a polyvalent carboxylic ester, or a derivative thereof, as described above. Modified polyester resins, for example, reactive precursors (prepolymers), and resins obtained by cross-linking and/or elongation reaction of such prepolymers, do not belong to the aforementioned crystalline polyester resins.

-Polyvalent Alcohol-

Polyvalent alcohols are not particularly limited and can be appropriately selected according to the purpose. For example, diols and trivalent or higher alcohols can be used.

Examples of the diol include saturated aliphatic diols. The saturated aliphatic diols include linear saturated aliphatic diols and branched saturated aliphatic diols. Among them, linear saturated aliphatic diols are preferably used, and linear saturated aliphatic diols having 2 to 12 carbons are more preferably used. If the saturated aliphatic diol is a branched type, the crystallinity of the crystalline polyester resin may be decreased and the melting point of the crystalline polyester resin may be lowered. If the carbon number of the saturated aliphatic diol exceed 12, it becomes difficult to obtain the material for practical use.

Examples of the saturated aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosandecanediol, and the like. Among these, ethylene glycol, 1,4-butanediol, 1,6-hexanediol, 1,8-octanediol, 1,9-nonanediol, 1,10-decanediol, and 1,12-dodecanediol are preferably used because the crystalline polyester resin has high crystallinity and excellent sharp-melting properties.

Examples of trivalent or higher alcohols include glycerin, trimethylolethane, trimethylolpropane, pentaerythritol, and the like. These may be used alone or in combination of two or more.

-Polyvalent Carboxylic Acid-

Polyvalent carboxylic acids are not particularly limited and can be appropriately selected according to the purpose. For example, divalent carboxylic acids and trivalent or higher carboxylic acids can be used.

Examples of divalent carboxylic acids include saturated aliphatic dicarboxylic acids such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, 1,18-octadecanedicarboxylic acid, and the like; aromatic dicarboxylic acids such as phthalic acid, isophthalic acid, terephthalic acid, naphthalene-2,6-dicarboxylic acid, malonic acid, mesaconic acid, and the like; and the like. In addition, these anhydrides and these lower (having 1 to 3 carbons) alkyl esters are also used. Among them, saturated aliphatic groups having 12 or less carbons of plant-derived saturated aliphatic groups are preferably used from a carbon-neutral standpoint.

Examples of trivalent or higher carboxylic acids include 1,2,4-benzenetricarboxylic acid, 1,2,5-benzenetricarboxylic acid, 1,2,4-naphthalenetricarboxylic acid, and their anhydrides and their lower (having 1 to 3 carbons) alkyl esters. These may be used alone or in combination of two or more.

The crystalline polyester resin is preferably composed of a linear saturated aliphatic dicarboxylic acid having 4 to 12 carbons and a linear saturated aliphatic diol having 2 to 12 carbons. Such structure enables an excellent low-temperature fixability to be exerted because of the high crystallinity and excellent sharp-melt properties.

In addition, methods for controlling the crystallinity and softening point of crystalline polyester resins include designing and using non-linear polyesters or the like that undergo condensation polymerization by adding trivalent or higher polyvalent alcohol such as glycerin to the alcohol component or trivalent or higher polyvalent carboxylic acid such as trimellitic anhydride to the acid component during polyester synthesis.

The molecular structure of crystalline polyester resins can be confirmed by NMR measurements in solutions and solids, as well as X-ray diffraction, GC/MS, LC/MS, IR measurements, and the like. However, in the infrared absorption spectra, examples can be taken that have absorption based on the δCH (out-of-plane bending vibration) of olefins at 965±10 cm⁻¹ or 990±10 cm⁻¹.

In terms of molecular weight, those with a sharp molecular weight distribution and a low molecular weight are excellent in low-temperature fixability, while many components with a low molecular weight deteriorate heat-resistant storage. From this point of view, it is preferable that the molecular weight distribution by GPC of the soluble part of o-dichlorobenzene has a peak position in the range of 3.5 to 4.0 on the molecular weight distribution map with log (M) on the horizontal axis and % by mass on the vertical axis, a peak width at half maximum of 1.5 or less, a weight-average molecular weight (Mw) of 3,000 to 30,000, a number-average molecular weight (Mn) of 1,000 to 10,000, and a weight-average molecular weight (Mw) to number-average molecular weight (Mn) ratio Mw/Mn of 1 to 10.

Furthermore, it is more preferable that the weight-average molecular weight (Mw) is 5,000 to 15,000, the number-average molecular weight (Mn) is 2,000 to 10,000, and the ratio of Mw/Mn is 1 to 5.

The acid value of the crystalline polymer is preferably 5 mgKOH/g or more in order to achieve the desired low-temperature fixability in terms of the affinity between paper and resin. For the preparation of fine particles by the phase transfer emulsification method, the acid value of the crystalline polyester resin is more preferably 7 mgKOH/g or more. In order to improve the hot offsetting property, the acid value of the crystalline polyester resin is preferably 45 mgKOH/g or less. In addition, the hydroxyl value of the crystalline polymer is preferably 0 to 50 mgKOH/g and more preferably 5 to 50 mgKOH/g in order to achieve the predetermined low-temperature fixability and to achieve excellent chargeability characteristics.

[Colorant]

The colorant contains at least one isoindoline pigment. The addition of the isoindoline pigment, which is highly weather-resistant, prevents discoloration of the resin particles, which is caused by a decrease in strength due to the combined use of plant-derived resin and PET and a deterioration in weatherability due to fragility.

The additive amount of isoindoline pigment is preferably adjusted according to the amount of plant-derived resin and PET used. When the content of isoindoline pigment is A, the concentration of radioisotope ¹⁴C in the resin particles is B, and the content of PET is C, it is preferable to satisfy (A/(B+C))>1/20, and more preferably (A/(B+C))>1/15. In other words, it is preferable that the isoindoline pigment is contained in an amount exceeding 5% with respect to the sum of the amount of biomass raw material in the resin particles and the content of PET. When (A/(B+C)) exceeds 1/20, the isoindoline pigment can be added to suppress discoloration even in severe environments.

Known dyes and pigments can be used as colorants. Examples of the colorants may include naphthol yellow S, hansa yellow (10G, 5G, G), cadmium yellow, yellow iron oxide, loess, chrome yellow, titan yellow, polyazo yellow, oil yellow, hansa yellow (GR, A, RN, R), pigment yellow L, benzidine yellow (G, GR), permanent yellow (NCG), vulcan fast yellow (5G, R), tartrazine lake, quinoline yellow lake, anthracite yellow BGL, and the combination thereof.

(Reactive Precursor)

The resin particles in one embodiment may contain a reactive precursor (prepolymer) that is an amorphous resin to improve low-temperature fixability.

The reactive precursor includes a polyester resin having a group that can react with an active hydrogen group.

The group that can react with the active hydrogen group includes, for example, an isocyanate group, an epoxy group, a carboxylic acid, an acid chloride group, and the like.

The reactive precursor may have a branched structure imparted by at least one of a trivalent or higher alcohol and a trivalent or higher carboxylic acid.

Examples of the polyester resin containing an isocyanate group include a reaction product of a polyester resin with an active hydrogen group and a polyisocyanate.

The polyester resin with an active hydrogen group is obtained, for example, by polycondensation of a diol, a dicarboxylic acid, and at least one of a trivalent or higher alcohol and a trivalent or higher carboxylic acid.

The trivalent or higher alcohols and trivalent or higher carboxylic acids impart branched structures to polyester resins containing isocyanate groups.

Examples of diols include aliphatic diols such as ethylene glycol, 1,2-propylene glycol, 1,3-propylene glycol, 1,4-butanediol, 2-methyl-1,3-propanediol, 1,5-pentanediol, 3-methyl-1,5-pentanediol, 1,6-hexanediol, 1,8-octanediol, 1,10-decanediol, 1,12-dodecanediol, and the like; diols with oxyalkylene groups such as diethylene glycol, triethylene glycol, dipropylene glycol, polyethylene glycol, polypropylene glycol, polytetramethylene glycol, and the like; alicyclic diols such as 1,4-cyclohexanedimethanol, hydrogenated bisphenol A, and the like; alkylene oxides such as ethylene oxide, propylene oxide, butylene oxide added to alicyclic diols; bisphenols such as bisphenol A, bisphenol F, bisphenol S, and the like; and alkylene oxide adducts of bisphenols, such as bisphenols to which alkylene oxides such as ethylene oxide, propylene oxide, and butylene oxide are added. These diols may be used alone or in combination of two or more.

Examples of dicarboxylic acids include aliphatic dicarboxylic acids such as succinic acid, adipic acid, sebacic acid, dodecanedioic acid, maleic acid, fumaric acid, and the like; aromatic dicarboxylic acids such as phthalic acid, isophthalic acid, terephthalic acid, naphthalene dicarboxylic acid, and the like. These anhydrides, lower (having 1 to 3 carbons) alkyl esters and halides may also be used. These dicarboxylic acids may be used alone or in combination of two or more.

Examples of trivalent or higher alcohols include trivalent or higher aliphatic alcohols such as glycerin, trimethylolethane, trimethylolpropane, pentaerythritol, sorbitol, and the like; trivalent or higher polyphenols such as trisphenol PA, phenol novolac, cresol novolac, and the like; alkylene oxide adducts of trivalent or more polyphenols, such as polyphenols with alkylene oxides such as ethylene oxide, propylene oxide, butylene oxide, and the like; and the like.

The trivalent or higher carboxylic acids include, for example, trivalent or higher aromatic carboxylic acids. Especially, trivalent or higher aromatic carboxylic acids having 9 to 20 carbons such as trimellitic acid, pyromellitic acid, and the like are preferably used. Furthermore, these anhydrates, lower (having 1 to 3 carbons) alkyl esters, and halides may also be used.

Examples of polyisocyanates include diisocyanates, trivalent or higher isocyanates, and the like.

Polyisocyanates are not particularly limited and can be appropriately selected for the intended purpose. Examples of polyisocyantes include aromatic diisocyanates such as 1,3- and/or 1,4-phenylenediisocyanate, 2,4- and/or 2,6-tolylene diisocyanate (TDI), crude TDI, 2,4′- and/or 4,4′-diphenylmethane diisocyanate (MDI), crude MDI [a phosgene product of crude diaminophenylmethane (condensation product of formaldehyde with aromatic amines (aniline) or mixtures thereof; a mixture of diaminodiphenylmethane and a small amount (e.g., 5 to 20% by mass) of tri-functional or higher polyamine): polyaryl polyisocyanates (PAPI)], 1,5-naphthylene diisocyanate, 4,4′,4″-triphenylmethane triisocyanate, m- and p-isocyanatophenylsulfonyl isocyanates, and the like; aliphatic diisocyantes such as ethylene diisocyanate, tetramethylene diisocyanate, hexamethylene diisocyanate (HDI), dodecamethylene diisocyanate, 1,6,11-undecane triisocyanate, 2,2,4-trimethyl hexamethylene diisocyanate, lysine diisocyanate, 2,6-diisocyanatomethyl caproate, bis(2-isocyanatoethyl) fumarate, bis(2-isocyanatoethyl) carbonate, 2-isocyanatoethyl-2,6-diisocyanatohexanoate, and the like; alicyclic diisocyanates such as isophorone diisocyanate (IPDI), dicyclohexylmethane-4,4′-diisocyanate (hydrogenated MDI), cyclohexyl diisocyanate, methylcyclohexyl diisocyanate (hydrogenated TDI), bis(2-isocyanatoethyl)-4-cyclohexene-1,2-dicarboxylate, 2,5- and 2,6-norbornane diisocyanates; aromatic aliphatic diisocyanates such as m- and p-xylylene diisocyanates (XDI), α,α′,α′,α′-tetramethylxylylene diisocyanates (TMXDI), and the like; trivalent or higher polyisocyanates such as lysine triisocyanate, trivalent or higher alcohols of diisocyanate denaturation, and the like; and modified product of these isocyanates. Alternatively, a mixture of two or more of these can be used. Examples of the modified products of the isocyanate include modified products containing a urethane group, carbodiimide group, allophanate group, urea group, burette group, urethodione group, ureteimine group, isocyanurate group, and oxazolidone group.

[Other Components]

The resin particles of one embodiment may contain other components. Examples of other components include wax, external additives, charge controlling agents, cleanability improver, magnetic materials, and the like.

(Wax)

The wax is not particularly limited and can be selected appropriately according to the purpose, but a release agent with a low melting point of 50° C. to 120° C. is preferably used. When the wax having low-temperature melting point is dispersed with the resin, the wax as a release agent effectively acts between fixing rollers and the interfaces of the resin particles, thereby providing excellent hot offset even without oil (no release agent like oil is applied to the fixing roller).

The release agents preferably include, for example, waxes or the like. The waxes include, for example, natural waxes including botanical waxes such as carnauba wax, cotton wax, japan wax, and rice wax; animal waxes such as beeswax, and lanolin; mineral-based waxes such as ozocerite, and ceresin; and petroleum waxes such as paraffin, microcrystalline, and petrolatum; and the like. The waxes include, for example, natural waxes including botanical waxes such as carnauba wax, cotton wax, japan wax, and rice wax; animal waxes such as beeswax, and lanolin; mineral-based waxes such as ozocerite, and ceresin; and petroleum waxes such as paraffin, microcrystalline, and petrolatum; and the like. Furthermore, aliphatic acid amides such as 12-hydroxystearic acid amide, amide stearate, phthalimide anhydride, or chlorinated hydrocarbons; homopolymers or copolymers of polyacrylate such as poly-n-stearyl methacrylate, or poly-n-lauryl methacrylate, which is a crystalline high polymer resin with a low molecular weight (e.g. a copolymer of n-stearyl acrylate-ethyl methacrylate); a crystalline polymer having a long alkyl group in the side chain; and the like may be used. The above-described polymers may be used singly, or a combination of two or more polymers may be used.

From the viewpoint of reducing environmental load, plant-based wax is preferably used.

The melting point of the wax is not particularly limited, and can be appropriately selected according to the purpose. The melting point preferably is within a range from 50° C. to 120° C., and more preferably is within a range from 60° C. to 90° C. When the melting point is 50° C. or higher, it is possible to suppress bad influence brought from the wax to the heat-resistant storage. When the melting point is 120° C. or lower, it is possible to effectively suppress an occurrence of a cold offset at the time of fixing at low temperature. A melt viscosity of the wax, as a measured value at a temperature higher than the melting point of the wax by 20° C., preferably is within a range from 5 cps to 1,000 cps, and more preferably is within a range from 10 cps to 100 cps. When the melt viscosity is 5 cps or more, it is possible to retain acceptable releasability. When the melt viscosity is 1,000 cps or less, effects of hot offset resistance and the low temperature fixability can be exhibited sufficiently. The content of the wax in the resin particles is not particularly limited, and can be appropriately selected according to the purpose. The content preferably is within a range from 0% by mass to 40% by mass, and more preferably is within a range from 3% by mass to 30% by mass. If the wax content is 40% by mass or less, deterioration of toner flowability can be prevented.

(External Additive)

Inorganic fine particles and polymeric fine particles can be used as the external additive.

Examples of the inorganic fine particles include silica, alumina, titanium oxide, barium titanate, magnesium titanate, calcium titanate, strontium titanate, iron oxide, copper oxide, zinc oxide, tin oxide, silica sand, clay, mica, silica stone, diatomaceous earth, chromium oxide, cerium oxide, bengara, antimony trioxide, magnesium oxide, zirconium oxide, barium sulfate, barium carbonate, calcium carbonate, silicon carbide, silicon nitride, and the like. Among these, silica, alumina, and titanium oxide are preferably used.

In addition, the inorganic fine particles may be surface-treated with a hydrophobizing agent to enhance their hydrophobicity and suppress deterioration of their flow and chargeability characteristics even under high humidity. Examples of the hydrophobizing agents include silane coupling agents, silylating agents, silane coupling agents with alkyl fluoride groups, organic titanate-based coupling agents, aluminum-based coupling agents, silicone oils, modified silicone oils, and the like.

Examples of the polymeric fine particles include polystyrene obtained by soap-free emulsion polymerization, suspension polymerization, and dispersion polymerization, polycondensation systems such as methacrylate and acrylic ester copolymers, silicon, benzoguanamine and nylon, and polymer particles made of thermosetting resins.

The average particle size of the primary particles of the inorganic fine particles is not particularly limited and can be appropriately selected according to the purpose, but is preferably 5 nm to 2 μm, more preferably 10 nm to 500 nm. If the average particle size is 5 nm or more, the agglomeration of the inorganic fine particles is suppressed and the inorganic fine particles can be uniformly dispersed in the resin particles. If the average particle size is 2 μm or less, the filler effect improves the heat-resistant storage.

Note that the average particle size is the value obtained directly from the photograph obtained by transmission electron microscopy, and it is preferable to observe at least 100 or more particles and use the average of their major diameters.

The specific surface area of the inorganic fine particles by the BET method is preferably 20 m²/g to 500 m²/g.

The content of the inorganic fine particles is preferably 0.01% by mass to 5% by mass of the resin particles.

(Charge Controlling Agent)

General charge controlling agents can be used as a charge controlling agent in the present embodiment. Examples of the charge controlling agents include nigrosine-based dyes, triphenylmethane-based dyes, chromium-containing metal complex dyes, molybdate chelate pigments, rhodamine-based dyes, alkoxy amines, quaternary ammonium salts (including fluorine-modified quaternary ammonium salts), alkylamides, single or compound of phosphorus, single or compound of tungsten, fluorine-based activators, metal salicylate salts, metal salts of salicylic acid derivatives, and the like. Specific examples of the charge controlling agents include Bontron 03 for nigrosine dyes, Bontron P-51 for quaternary ammonium salts, Bontron S-34 for metal-containing azo dyes, E-82 for oxynaphthoic acid metal complexes, E-84 for salicylic acid metal complexes, E-89 for phenolic condensates (manufactured by Orient Chemical Industries, Inc.), TP-302 and TP-415 for quaternary ammonium salt molybdenum complexes (manufactured by Hodogaya Chemical Co., Ltd.), copy charge PSY VP 2038 for quaternary ammonium salts, copy blue PR for triphenylmethane derivatives, copy charge NEG VP 2036 for quaternary ammonium salts, copy charge NX VP 434 (manufactured by Hoechst.), LRA-901, boron complex LR-147 (manufactured by Japan Carlit), copper phthalocyanine, perylene, quinacridone, azo pigments, and other polymeric compounds with functional groups such as sulfonic acid groups, carboxyl groups, and quaternary ammonium salts. The charge controlling agents may be used in an amount in the range of performance that does not disturb the fixability and the like. The charge controlling agent is contained in an amount of 0.5% by mass to 5% by mass and more preferably in an amount of 0.8% by mass to 3% by mass in the resin particles.

(Cleanability Improver)

The cleanability improvers are not particularly limited as long as the cleanability improvers are added to the resin particles to remove any post-transfer developer that remains on a photoconductor and a primary transfer medium, and can be appropriately selected according to the purpose. Examples of the cleanability improvers include fatty acid metal salts such as zinc stearate, calcium stearate, stearic acid, and the like; polymer fine particles produced by soap-free emulsion polymerization such as polymethyl methacrylate fine particles, polystyrene fine particles, and the like. The polymer fine particles preferably have a relatively narrow particle size distribution, and those with a volume average particle size of 0.01 μm to 1 μm are preferably used.

(Magnetic Material)

The magnetic material is not particularly limited and can be appropriately selected from the known materials according to the purpose. Examples of the magnetic materials include iron powder, magnetite, ferrite, and the like. Among these, white ones are preferable in terms of color tone.

<Method of Producing Resin Particles>

A method of producing resin particles according to one embodiment will be described. The method of manufacturing resin particles according to one embodiment includes an oil phase preparation step, an aqueous phase preparation step, a phase transfer emulsification step, a desolvating step, an agglomerating step, and a fusing step, and further includes other steps such as a shelling step, a washing step, a drying step, an annealing step, and an external additive step as necessary.

[Oil Phase Preparation Step]

In the method of producing resin particles according to one embodiment, an oil phase is first prepared by dissolving or dispersing resin, colorant, cross-linking component, wax, or the like in an organic solvent.

In the method of preparing the oil phase, the resin, colorant, or the like may be added into the organic solvent with stirring to dissolve or disperse them. For dispersion, known dispersing machines such as bead mills and disk mills can be used.

Each raw material used in the oil phase preparation step may be those described in the above <Resin Particles>. These may be used alone or in combination of two or more. For example, a charge controlling agent or the like may be added to the oil phase.

(Organic Solvents)

Although the organic solvent is not particularly limited and can be appropriately selected according to the purpose, it is preferable to use a volatile solvent with a boiling point of less than 100° C. because the volatile solvent makes it easier to remove the organic solvent later. Examples of the organic solvents include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, methanol, ethanol, isopropyl alcohol, or the like. These can be used alone or in combination of two or more kinds. When the resin to be dissolved or dispersed in the organic solvent is a resin having a polyester skeleton, ester solvents such as methyl acetate, ethyl acetate, and butyl acetate or ketone solvents such as methyl ethyl ketone and methyl isobutyl ketone are preferably used because of their high solubility and solvent removal properties.

[Aqueous Phase Preparation Step]

In the aqueous phase preparation step, the aqueous phase (aqueous medium) is prepared.

The aqueous medium is not particularly limited and can be selected from the known ones as appropriate, for example, water, solvents miscible with water, or mixtures thereof. The concentration of the organic solvent is preferably less than or equal to the saturation concentration with respect to the ion-exchanged water from the viewpoint of granulation.

Solvents that can be miscible with water are not particularly limited and can be selected from the known solvents, for example, alcohols, dimethylformamide, tetrahydrofuran, cellosolve, lower ketones, esters, or the like.

Examples of alcohols include methanol, isopropanol, ethylene glycol, or the like.

Examples of lower ketones include acetone or methyl ethyl ketone.

Examples of the esters include ethyl acetate.

These may be used alone or in combination of two or more.

(Phase Transfer Emulsification Step)

In the phase transfer emulsification step, the oil phase obtained in the oil-phase preparation step is made into fine particles.

After neutralizing the oil phase, ion-exchange water is added to the neutralized oil phase, and the fine particle dispersion liquid is obtained by phase transfer emulsification, in which the water-in-oil dispersion is transferred to the oil-in-water dispersion liquid.

The phase transfer emulsification is carried out with stirring.

The step is carried out by mixing and dispersing the mixture uniformly using a normal stirrer or a disperser.

As a stirring blade, there is no particular limitation, and a stirring blade can be selected appropriately according to the viscosity of the solution. Examples of stirring blade include low-viscosity stirring blades such as paddles, propellers, and the like; medium-viscosity stirring blades such as anchors, max blends, and the like; and high-viscosity stirring blades such as helical ribbons and the like.

Examples of dispersers include, but are not limited to, ultrasonic dispersers, bead mills, ball mills, roll mills, homo mixers, ultra-mixers, dispersion mixers, penetrating high-pressure dispersers, colliding high-pressure dispersers, porous high-pressure dispersers, ultra-high pressure homogenizers, ultrasonic homogenizers, or the like. Regular stirrers and dispersers may be used in combination.

Among these, paddles and anchors are preferably used in that the volume average particle size of the dispersions (oil droplets) can be controlled within the above desirable range.

Either a basic inorganic compound or a basic organic compound may be used as the base for neutralizing the oil phase. Examples of basic inorganic compounds include sodium hydroxide, potassium hydroxide, lithium hydroxide, ammonia, sodium carbonate, sodium bicarbonate, potassium carbonate, potassium bicarbonate, ammonia, and the like. Examples of basic organic compounds include N,N-dimethylethanolamine, N,N-diethylethanolamine, triethanolamine, tripropanolamine, tributanolamine, triethylamine, n-propylamine, n-butylamine, isopropylamine, monomethanolamine, morpholine, methoxypropylamine, pyridine, vinylpyridine, isophorone diamine, and the like.

When the stirring blade is used, the conditions such as the number of revolutions, the stirring time, the stirring temperature, and the like are not particularly limited and can be appropriately selected according to the purpose.

The number of revolutions is not particularly limited and is preferably from 100 rpm to 1,000 rpm, and more preferably from 200 rpm to 600 rpm.

The stirring time and stirring temperature are not particularly limited and may be selected as appropriate according to the purpose.

A dispersing agent may also be used if necessary. The dispersing agent is not particularly limited and can be selected appropriately according to the purpose. Examples of dispersing agents include surfactants, poorly water-soluble inorganic compound dispersants, polymeric protective colloids, and the like. These may be used alone or in combination of two or more. Among these, surfactants are preferably used.

The surfactants are not particularly limited and can be selected appropriately according to the purpose. Examples of surfactants include anionic surfactants, cationic surfactants, nonionic surfactants, amphoteric surfactants, and the like.

The anionic surfactants are not particularly limited and can be selected appropriately according to the purpose. Examples of anionic surfactants include alkylbenzene sulfonates, α-olefin sulfonates, phosphates, and the like. Among these, those having a fluoroalkyl group are preferably used.

[Desolvating Step]

In the desolvating step, the organic solvent is removed from the resulting fine particle dispersion.

To remove the organic solvent from the resulting fine particle dispersion, a method can be employed in which the entire system is stirred and the temperature of the entire system is gradually raised to completely evaporate the organic solvent in the droplets.

Alternatively, the resulting fine particle dispersion can be sprayed into a dry atmosphere with stirring to completely remove the organic solvent in the droplets. In addition, the fine particle dispersion may be reduced in pressure with stirring to evaporate and remove the organic solvent. Alternatively, the organic solvent may be evaporated and removed by blowing gas while stirring the fine particle dispersion.

These measures may be used alone or in combination.

As the drying atmosphere in which a colored fine particle dispersion is sprayed, various air currents heated to a temperature above the boiling point of the highest boiling solvent used are generally used, including air, nitrogen, carbon dioxide gas, combustion gas, and other heated gases. Short-term treatment of spray dryers, belt dryers, rotary kilns, or the like provides sufficient target quality.

The colored fine particle dispersion liquid can be obtained by removing the organic solvent from the obtained fine particle dispersion in the above manner.

[Agglomerating Step]

Then, the resulting colored fine particle dispersion liquid is agglomerated with stirring until it reaches the desired particle diameter to obtain agglomerated particles.

Conventional methods can be used to cause agglomeration, such as adding an agglomerating agent or adjusting pH. When an agglomerating agent is added, the agglomerating agent may be added as is, but the agglomerating agent is preferably converted into an aqueous solution so that a localized increase in concentration is avoided. In addition, the agglomerating agent is preferably gradually added while observing the particle size.

The temperature of the dispersion liquid during agglomeration is preferably near the glass transition temperature Tg of the resin used. If the liquid temperature of the colored fine particle dispersion liquid is too low, agglomeration will not appreciably proceed, resulting in poor efficiency. If the liquid temperature of the colored fine particle dispersion liquid is too high, the agglomeration rate increases, coarse particles are generated, and the particle size distribution deteriorates.

When the particle size becomes a desired particle size, the agglomeration is stopped. Methods for stopping agglomeration include adding salts or chelating agents with low ionic valence, adjusting the pH, lowering the temperature of the dispersion liquid, and diluting the concentration by adding a large amount of aqueous medium.

The dispersion liquid of the colored agglomerated particles can be obtained by the above method.

In the agglomerating step, a wax may be added as a releasing agent. In such cases, a dispersion liquid in which the wax is dispersed in an aqueous media or the wax is mixed with the colored fine particle dispersion liquid is agglomerated, resulting in obtaining agglomerated particles in which the wax or the crystalline resin is evenly dispersed.

(Agglomerating Agent)

A common agglomerating agent can be used as an agglomerating agent in the present embodiment. For example, metal salts of monovalent metals such as sodium and potassium, metal salts of divalent metals such as calcium and magnesium, and metal salts of trivalent metals such as iron and aluminum can be used as the agglomerating agent. One type of agglomerating agent may be used alone, or two or more types of agglomerating agents may be used in combination.

[Fusing Step]

In the fusing step, the resulting agglomerated particles are then fused by heat treatment to reduce irregularities, making the particles spherical. The fusion may be accomplished by heating the dispersion of the agglomerated particles while stirring the dispersion of the colored agglomerated particles. Preferably, the temperature of the liquid is around the temperature exceeding the glass transition temperature Tg of the resin being used.

[Shelling Step]

After the fusing step, the spherically shaped particles obtained in the fusing step may be shelled as needed to form a shell layer on the surface of the spherically shaped particles. As a method of forming the shell layer, for example, after spherically shaped particles of the desired particle size are produced in the fusing step, an amorphous resin is added and the agglomeration and fusing steps are repeated to form a shell layer on the spherically shaped particles obtained in the fusing step.

[Washing and Drying Steps]

In the washing and drying steps, only resin particles are removed from the colored agglomerated particle dispersion liquid obtained by the above method, followed by washing and drying.

Since the colored agglomerated particle dispersion liquid obtained by the above-described method contains a secondary material such as agglomerated salt in addition to the resin particles, washing is performed in order to remove only the resin particles from the dispersion liquid. Methods of washing the colored resin particles include a centrifugal separation method, a reduced-pressure filtration method, and a filter press method. The methods of washing the colored resin particles are not particularly limited in the present embodiment. A cake body of the colored resin particles can be obtained by either method. If the colored resin particles cannot be sufficiently washed in a single operation, the cake obtained can be dispersed in an aqueous solvent again to make a slurry, and the step of removing the colored resin particles by either of the above methods can be repeated. If the washing is performed by a reduced-pressure filtration or filter press method, an aqueous solvent may be used to penetrate the cake and wash away the secondary materials contained in the resin particles. As the aqueous medium used for this washing, water or a mixture of water and an alcohol such as methanol or ethanol are used. Water is preferably used in view of reducing cost and environmental load caused by, for example, drainage treatment.

Since the washed colored agglomerated particles contain a large amount of aqueous medium, the washed colored agglomerated particles are dried so that the colored agglomerated particles with nothing else included can be obtained.

As the drying method, a dryer such as a spray dryer, a vacuum freeze dryer, a reduced-pressure dryer, a static dryer, a mobile dryer, a fluidized dryer, a rotary dryer, a stirred dryer, or the like, can be used. The dried color resin particles are preferably dried until the final moisture content is less than 1%. If the colored resin particles after drying are agglomerated and impractical for use, the agglomerated particles may be pulverized using a device such as a jet mill, a Henschel mixer, a super mixer, a coffee mill, an Oster blender, or a hood processor to break up the agglomerated particles.

[Annealing Step]

When crystalline resin is added, the crystalline resin and the amorphous resin are phase separated by annealing after drying, thereby improving fixing property. Specifically, the product should be stored at a temperature around Tg for at least 10 hours.

[External Additive Step]

Other components such as an external additive agent, a cleaning improver, and the like may be added to the resulting resin particles so as to provide fluidity, chargeability, cleaning property, or the like.

Suitable methods may include, for example, applying an impact to the mixture using blades rotating at a high speed, throwing the mixture into a high-speed airflow to accelerate the mixture, and causing the particles to collide with each other or causing the particles to collide with an impact plate, and the like.

A device to be used for applying the mechanical impact to the mixture can be appropriately selected according to the purpose. For the device, angmill (manufactured by Hosokawa Micron Corporation), a device obtained by modifying I-type mill (manufactured by Nippon Pneumatic Mfg. Co., Ltd.) to reduce a pulverizing air pressure, a hybridization system (manufactured by Nara Machinery Co., Ltd.), Kryptron (trademark registered) (manufactured by Kawasaki Heavy Industries, Ltd.), automatic mortar, or the like, may be used.

As described above, by carrying out the oil phase preparation step, the aqueous phase preparation step, the phase transfer emulsification step, the desolvating step, the agglomerating step, and the fusing step, and further carrying out other steps such as the shelling step, the washing step, the drying step, the annealing step, and the external additive step as necessary, the resin particles of one embodiment can be obtained.

[Characteristics of Resin Particles]

Methods of measuring the following characteristics of resin particles are described.

(Measurement of Radioisotope ¹⁴C Concentration)

The radioisotope ¹⁴C concentration of resin particles is measured by radiocarbon dating. Resin particles are burned to reduce their carbon dioxide (CO₂) to obtain graphite (C). The concentration of ¹⁴C in graphite is measured using an Accelerator Mass Spectroscopy (AMS), manufactured by Beta Analytic. This AMS measurement is disclosed, for example, in Japanese Patent No. 4050051 and the like.

(Measurement of Particle Size of Resin Particles)

The particle size of resin particles in one embodiment was measured by Coulter Multisizer III (manufactured by Beckman Coulter, Inc.). The particle size of resin particles is measured as follows. First, 2 mL of a surfactant (Sodium dodecylbenzenesulfonate, manufactured by Tokyo Chemical Industry Co., Ltd.) as a dispersant is added to 100 mL of an electrolyte. The electrolyte was prepared with about 1% NaCl aqueous solution using extra pure sodium chloride, and ISOTON-II (manufactured by Beckman Coulter, Inc.) was used. 10 mg of the measured sample in the solid content was further added to the mixture of the electrolyte and surfactant to obtain an electrolyte in which the sample was suspended. The electrolyte in which the sample was suspended was subjected to dispersion treatment in an ultrasonic disperser for several minutes (for example, about 1 to 3 minutes), and the volume and number of toner particles were measured by Coulter Multisizer III using a 100 μm aperture as the aperture to calculate the volume distribution and number distribution. From the obtained distribution, the volume average particle size (Dv) of the toner was obtained.

(Measurement of Melting Point and Glass Transition Temperature (Tg))

The melting point and glass transition temperature (Tg) can be measured using, for example, a DSC system (differential scanning calorimeter) (Q-200, manufactured by TA Instruments). Specifically, the melting point and glass transition temperature of the target sample can be measured by the following procedure. First, about 5.0 mg of the target sample is placed in an aluminum sample container, the sample container is placed on a holder unit and set in an electric furnace. Then, the sample is heated under a nitrogen atmosphere from −80° C. to 150° C. at a heating rate of 10° C./min (first heating). Then, the sample is cooled from 150° C. to −80° C. at a cooling rate of 10° C./min. Then, the sample is further heated to 150° C. at a heating rate of 10° C./min (second heating). At each of the first and second heating, the DSC curve is measured using a differential scanning calorimeter (Q-200, manufactured by TA Instruments). From the obtained DSC curve, the analysis program in the Q-200 system can be used to select the DSC curve at the first heating to determine the glass transition temperature at the first heating of the target sample.

From the obtained DSC curve, the analysis program in the Q-200 system can be used to select the DSC curve at the first heating to determine the endothermic peak top temperature at the first heating of the target sample as the melting point. Similarly, the DSC curve at the second heating can be selected and the endothermic peak top temperature at the second heating of the target sample can be obtained as the melting point.

(Measurement of Molecular Weight)

The molecular weight of each component of resin particles can be measured by, for example, the following methods.
Gel Permeation Chromatography (GPC) measuring device: GPC-8220 GPC (manufactured by Tosoh Co., Ltd.)
Column: TSKgel SuperHZM-H 15 cm three mixed bed columns (manufactured by Tosoh Co., Ltd.) Temperature: 40° C.
Solvent: THF
Flow rate: 0.35 mL/min
Sample: 100 μL injection of 0.15% by mass of a sample
Sample preparation: After dissolving a toner in tetrahydrofuran THF (Stabilizer included, manufactured by Wako Pure Chemical) at 0.15% by mass, filter through a 0.2 μm filter, and use the filtrate as a sample. Measure by injecting 100 μL of the above THF sample solution.

When measuring the molecular weight of a sample, the molecular weight distribution of the sample is calculated from the relationship between the logarithm of the calibration curve made of several monodisperse polystyrene standard samples and the count number. The standard polystyrene sample for preparing the calibration curve is Std. No S-7300, S-210, S-390, S-875, S-1980, S-10.9, S-629, S-3.0, S-0.580, of Showdex STANDARD, manufactured by Showa Denko K.K. A refractive index (RI) detector is used for the detections.

As described above, the resin particles in one embodiment contain a binder resin and a colorant, the binder resin contains PET, the colorant contains an isoindoline pigment, and the radioisotope ¹⁴C concentration of the resin particles is 5.4 pMC or higher. The resin particles in one embodiment contain PET as the binder resin and isoindoline pigment as the colorant, so that even if PET is replaced with a petroleum-derived resin and contains a biomass-derived resin, cracking of the resin particles can be suppressed and transmission of ultraviolet rays can be suppressed, thereby suppressing degradation of the resin particles. For this reason, the resin particles in one embodiment can reduce the deterioration of the resin particles due to the structural difference of the biomass-derived resin affecting the characteristics of the resin particles while enhancing the environmental responsiveness. Therefore, the resin particles in one embodiment can have high weather resistance even when plant-derived resin and PET are used as the binder resin.

The resin particles in one embodiment can have a radioisotope ¹⁴C concentration of 10 pMC to 70 pMC in the resin particles. Thus, the resin particles in one embodiment can reduce their environmental impact.

The resin particles in one embodiment can have (A/(B+C)) of 1/20 or more when the content of isoindoline pigment is A, the concentration of radioisotope ¹⁴C in the resin particles is B, and the content of polyethylene terephthalate is C. Thus, even if the resin particles are placed in a severe environment, the isoindoline pigment can be included in the resin particles to the extent that discoloration does not occur. Thus, the resin particles in one embodiment can be prevented from causing discoloration even in a severe environment.

The resin particles in one embodiment can have (A/(B+C)) of 1/15 or more. Thus, the resin particles in one embodiment can further stably suppress discoloration even in a severe environment.

Since the resin particles in one embodiment have the above characteristics, the resin particles can be effectively used as materials for image formation such as toner, developer, toner set, toner housing unit and image forming apparatus.

<Toner>

The toner according to one embodiment contains the resin particles according to one embodiment and may be formed from the resin particles of one embodiment.

By using the resin particles of one embodiment as a toner, the environmental load can be reduced, and even if plant-derived resin and PET are used as a binder resin, the toner having high weather resistance and having excellent environmental responsiveness, low-temperature fixability, and heat-resistant storage stability can be provided, resulting in providing high quality images.

<Developer>

The developer of one embodiment includes the toner of one embodiment and may include other components, such as carriers, which are selected as appropriate, as needed. As a result, the developer with excellent transferability, chargeability characteristics, and the like can be provided, stably forming high quality images.

The developer may be a single-component developer or a two-component developer. In the case where the developer is used for a high-speed printer, or the like, that can handle the recent enhancement in the information processing speed, from a point of enhancing the service life of the printer, the two-component developer is preferably used.

When the toner according to one embodiment is used as a single-component developer, the toner having high weather resistance and having excellent environmental responsiveness, low-temperature fixability, and heat-resistant storage stability can be provided, obtaining high-quality images.

If the developer of one embodiment is used in the two-component developer, it can be mixed with a carrier as a developer. If the toner of one embodiment is used in the two-component developer, the toner having high weather resistance and having excellent environmental responsiveness, low-temperature fixability, and heat-resistant storage stability can be provided, obtaining high-quality images.

The content of the carrier in the two-component developer can be appropriately determined according to the purpose. The content preferably is within a range from 90 parts by mass to 98 parts by mass, and more preferably is within a range from 93 parts by mass to 97 parts by mass relative to 100 parts by mass of the two-component developer.

The developer according to the embodiment of the present application can preferably be used to form images using the conventional electrophotography, such as a magnetic single-component development method, a nonmagnetic single-component development method, or a two-component development method.

[Carrier]

The carrier is not particularly limited and can be appropriately selected according to the purpose, but the carrier preferably has a core material and a resin layer (coating layer) covering the core material.

(Core Materials)

The material of core is not particularly limited, and can be appropriately selected according to the purpose. Suitable materials of the core may include, for example, manganese-strontium based materials with a magnetization that is within a range from 50 emu/g to 90 emu/g and manganese-magnesium based materials with magnetization that is within a range from 50 emu/g to 90 emu/g. Moreover, to secure an image density, iron powder with a magnetization of 100 emu/g or greater, and a high magnetization material such as magnetite with magnetization that is within a range from 75 emu/g to 120 emu/g are preferably used. Moreover, a low magnetization material such as copper-zinc based material with magnetization that is within a range from 30 emu/g to 80 emu/g is preferably used because an impact of the developer held in the form of a brush against the photoconductor can be reduced, and it is advantageous for improving the image quality. The above-described materials may be used singly, or a combination of two or more materials may be used.

The volume average particle diameter of the core is not particularly limited, and can be appropriately determined according to the purpose. The volume average particle diameter preferably is within a range from 10 μm to 150 μm, and more preferably is within a range from 40 μm to 100 μm. When the volume average particle diameter is 10 μm or more, it is possible to effectively suppress problems such as increases in the amount of fine powders in the carrier, decreases in the magnetization per individual particle, and scattering of the carriers. Meanwhile, when the volume average particle diameter is 150 μm or less, it is possible to effectively suppress problems such as decreases in the specific surface area, occurrence of scattering of the toner, and poor reproduction of solid image portion in a full-color image including a lot of solid image portions.

(Resin Layer)

The materials of the resin layer are not particularly limited and can be selected appropriately from among known resins according to the purpose. Examples the material of the resin layer include amino-based resins, polyvinyl-based resins, polystyrene-based resins, polyhalogenated olefins, polyester-based resins, polycarbonate-based resins, polyethylene, polyvinyl fluoride, polyvinylidene fluoride, polytrifluoroethylene, polyhexafluoropropylene, copolymers of vinylidene fluoride and acrylic monomers, copolymers of vinylidene fluoride and vinyl fluoride, fluoroterpolymers such as copolymers of tetrafluoroethylene, vinylidene fluoride and monomers without fluoro groups, silicone resins, and the like. These may be used alone or in combination of two or more.

Amino-based resins are not particularly limited and can be selected as appropriate according to the purpose, for example, urea-formaldehyde resin, melamine resin, benzoguanamine resin, urea resin, polyamide resin, epoxy resin, and the like.

Polyvinyl-based resin is not particularly limited and can be selected as appropriate according to the purpose, for example, acrylic resin, polymethyl methacrylate, polyacrylonitrile, polyvinyl acetate, polyvinyl alcohol, polyvinyl butyral, and the like.

Polystyrene-based resin is not particularly limited and can be selected as appropriate according to the purpose, for example, polystyrene, styrene-acrylic copolymer, and the like.

Polyhalogenated olefin is not particularly limited and can be selected as appropriate according to the purpose, for example, polyvinyl chloride, and the like.

The polyester-based resin is not particularly limited and can be selected appropriately according to the purpose, for example, polyethylene terephthalate, polybutylene terephthalate, and the like.

The resin layer may contain conductive powder, as needed. The conductive powder is not particularly limited and can be selected appropriately according to the purpose. Examples of the conductive powder include metal powder, carbon black, titanium oxide, tin oxide, zinc oxide, and the like. The average particle size of the conductive powder is preferably 1 μm or less. If the average particle size is 1 μm or less, the electrical resistance can be controlled.

The resin layer can be formed by preparing a coating solution by dissolving silicone resin or the like in a solvent, applying the coating solution to the surface of the core material using a known coating method, drying the coating solution, and then baking.

The coating method is not particularly limited and can be selected as appropriate according to the purpose, for example, a dip coating method, a spray method, a brush coating method, or the like can be used.

The solvent is not particularly limited and can be selected as appropriate according to the purpose, for example, toluene, xylene, methyl ethyl ketone, methyl isobutyl ketone, butyl acetate cellosolve, and the like.

The baking method may be an external heating method or an internal heating method. Examples of baking methods include a method using a fixed electric furnace, a fluidized electric furnace, a rotary electric furnace, a burner furnace, and microwaves.

The content of the resin layer in the carrier is not particularly limited and can be selected as appropriate according to the purpose. The content is preferably in a range from 0.01% by mass to 5.0% by mass. If the content of the resin layer is 0.01% by mass or more, a uniform resin layer can be formed on the surface of the core material. If the content is 5.0% by mass or less, the thickness of the resin layer is suppressed, so that fusion between carriers is suppressed and uniformity of carriers can be maintained.

<Developer Housing Container>

A developer housing container according to one embodiment stores the developer of one embodiment. The developer housing container is not particularly limited, and known containers can be appropriately selected for the intended purpose. The developer housing container has a container body and a cap.

In addition, although the size, shape, structure, material, and the like of the container body are not particularly limited, the shape is preferably cylindrical and the like. The shape is particularly preferable that the inner circumference has spiral-shaped irregularities, and that by rotating it, the content, developer, can migrate to the outlet side, and that some or all of the spiral-shaped irregularities have a bellows function. Furthermore, the material is not particularly limited, but the material is preferable to have good dimensional accuracy, for example, resin materials such as polyester resin, polyethylene resin, polypropylene resin, polystyrene resin, polyvinyl chloride resin, polyacrylic acid, polycarbonate resin, ABS resin, polyacetal resin, and the like.

The developer housing container is easy to store, transport, and so on, and is excellent in handling. Therefore, the developer housing container can be detachably attached to an image forming apparatus, process cartridge, and the like, described later, and used for replenishing the developer.

<Toner Housing Unit>

A toner housing unit according to the embodiment of the present application can store the toner of the embodiment of the present application. The toner housing unit according to the embodiment of the present application includes: a unit having a function of housing a toner; and a toner housed in the unit. Examples of the toner housing unit include, for example, a toner housing container, a developing unit, and a process cartridge.

The toner housing container refers to a container that stores a toner.

The developing unit refers to a unit that stores a toner and has a developing unit.

A process cartridge is one that includes at least an electrostatic latent image bearer and a developing device that are integrated, houses a toner, and is detachably attached to the image forming apparatus. The process cartridge may further be equipped with at least one selected from a chargeability part, an exposure part, a cleaning part, and the like.

The toner housing unit according to one embodiment houses the toner according to one embodiment, and the toner according to one embodiment has high weather resistance, and has excellent environmental responsiveness, low-temperature fixability, and heat-resistant storage stability. Therefore, the toner according to one embodiment can provide high-quality images. By mounting the toner housing unit according to one embodiment on an image forming apparatus and using the characteristics of the toner according to one embodiment to form an image, high-quality images can be stably formed over a long period of time with high weather resistance and excellent environmental responsiveness, low-temperature fixability, and heat-resistant storage stability.

<Image Forming Apparatus>

The image forming apparatus according to one embodiment has an electrostatic latent image bearer, an electrostatic latent image forming part that forms an electrostatic latent image on the electrostatic latent image bearer, and a developing part that develops the electrostatic latent image formed on the electrostatic latent image bearer using the toner to form a toner image, and can have other configurations as needed.

The image forming apparatus according to one embodiment is more preferably equipped with a transferring part for transferring the toner image onto a recording medium and a fixing part for fixing the transferred image onto the surface of the recording medium, in addition to the electrostatic latent image bearer, the electrostatic latent image forming part, and the developing part described above.

The toner according to one embodiment is used in the developing part. Preferably, a toner image may be formed by using the developer containing the toner of one embodiment and, if necessary, other components such as carriers or the like.

(Electrostatic Latent Image Bearer)

A material, a shape, a structure, a size, and the like of the electrostatic latent image bearer (sometimes referred to as “electrophotographic photoconductor” or “photoconductor”) are not particularly limited, and can be appropriately selected from the conventional electrostatic latent image bearers. The materials of the electrostatic latent image bearer include, for example, inorganic photoconductors such as amorphous silicon, selenium, an and the like; organic photoconductors (OPC) such as polysilane, phthalo polymethine, and the like. Among them, amorphous silicon is preferably used from the viewpoint of longevity, and organic photoconductor (OPC) is preferably used from the viewpoint of obtaining more high-resolution images.

As the amorphous silicon photoconductor, for example, a photoconductor having a photoconductive layer made of a-Si can be used by heating a support to 50° C. to 400° C. and forming a film on the support by vacuum deposition method, sputtering method, ion plating method, thermal Chemical vapor deposition (CVD) method, photo CVD method, plasma CVD method, or the like. Among these, the plasma CVD method, in which source gas is decomposed by direct current or radio frequency or microwave glow discharge to form a deposited a-Si film on the support, is preferably used.

The shape of the electrostatic latent image bearer is not particularly limited and can be selected appropriately according to the purpose, but a cylindrical shape is preferably used. The outer diameter of the cylindrical electrostatic latent image bearer is not particularly limited and can be selected appropriately according to the purpose. The outer diameter of the cylindrical electrostatic latent image bearer is preferably in a range from 3 mm to 100 mm, more preferably in a range from 5 mm to 50 mm, and particularly preferably 10 mm to 30 mm.

The linear velocity of the electrostatic latent image carrier is preferably 300 mm/s or more.

(Electrostatic Latent Image Forming Part)

The electrostatic latent image forming part is not particularly limited as long as the electrostatic latent image forming part is a device for forming an electrostatic latent image on the electrostatic latent image bearer, and can be selected appropriately according to the purpose. The electrostatic latent image forming part is provided with, for example, a charging member (charger) that uniformly charges the surface of the electrostatic latent image bearer and an exposure member (exposure device) that exposes the surface of the electrostatic latent image bearer in an image-like manner.

Chargers are not particularly limited and can be appropriately selected according to the purpose. Examples of chargers include contact chargers equipped with conductive or semiconducting rolls, brushes, films, rubber blades, and the like; and non-contact chargers such as corotrons, scorotrons, and the like using corona discharge.

The shape of the chargers can be any shape such as a magnetic brush, a fur brush, and the like, in addition to a roller and can be selected according to the specifications and shape of the image forming apparatus.

The charger is preferably arranged in contact or non-contact with the electrostatic latent image bearer, and charges the surface of the electrostatic latent image bearer by applying a superimposed direct current and alternating current voltage. The charger is preferably a charged roller arranged in close proximity to the electrostatic latent image bearer in a non-contact manner via a gap tape and charges the surface of the electrostatic latent image bearer by superimposing a direct current and an alternating current voltage on the charged roller.

Although the charger is not limited to a contact type charger. The charger is preferably a contact type charger that includes a charged member from a viewpoint of obtaining an image forming apparatus with reduced ozone generated from the charger.

The exposure device is not particularly limited as long as the exposure device can expose with an image to be formed onto the surface of the electrostatic latent image bearer charged by the charger, and can be appropriately selected according to the purpose. The exposure device includes, for example, various types of exposure devices such as a copying optical system, a rod lens array system, a laser optical system, a liquid crystal shutter optical system, and the like.

The light source used for the exposure device is not particularly limited and can be selected appropriately according to the purpose, for example, fluorescent lamps, tungsten lamps, halogen lamps, mercury lamps, sodium lamps, light emitting diodes (LED), semiconductor lasers (LD), electroluminescence (EL), and other luminous materials in general.

In addition, various filters such as a sharp cut filter, a bandpass filter, a near-infrared cut filter, a dichroic filter, an interference filter, and a light balancing filter, and the like can be used to emit only light in the desired wavelength range.

The exposure device may employ a light backplane system that exposes the image from the backside of the electrostatic latent image bearer.

(Developing Part)

The developing part is not particularly limited and can be selected appropriately according to the purpose, if the visible image can be formed by developing the electrostatic latent image formed on the electrostatic latent image bearer. For example, the developing part can suitably be equipped with a developing device that contains toner and can apply toner to the electrostatic latent image in a contact or non-contact manner, and the developing device with a toner-containing container is preferably used.

The developing device be a monochromatic developing device or a multicolor developing device. As the developing device, for example, a developing device having a stirrer for charging toner by friction stirring and a magnetic field generating part fixed inside the developing device, and a developer carrier (for example, a magnet roller) capable of being rotated by carrying a developer containing toner on the surface is suitably used.

(Transferring Part)

The transferring part is preferably configured to include a primary transferring part that transfers a visible image onto an intermediate transfer body to form a composite transfer image and a secondary transferring part that transfers the composite transfer image onto a recording medium. The intermediate transfer body is not particularly limited and can be selected from among known transfer bodies according to the purpose, and, for example, a transfer belt is preferably used.

The transferring part (primary transferring part and secondary transferring part) preferably has at least a transferring device that peels and charges the visible image formed on the electrostatic latent image bearer (photoconductor) onto the recording medium side. The transferring part may be one or two or more.

Examples of transferring devices include corona transfer devices by corona discharge, transfer belts, transfer rollers, pressure transfer rollers, adhesive transfer devices, and the like.

The recording medium is typically plain paper. The recording medium is not particularly limited as long as the recording medium is capable of transferring an unfixed image after developing an image, and any of the known recording media (recording paper) can be selected according to the purpose. PET bases for OHP and other materials can also be used.

(Fixing Part)

The fixing part is not particularly limited, and can be appropriately selected according to the purpose. The fixing part is preferably a conventional heating and pressurizing part. Examples of the heating and pressurizing parts include a combination of a heating roller and a pressurizing roller, a combination of a heating roller, a pressuring roller, an endless belt, and the like.

The fixing part preferably has a heating body that includes a heating element, a film that contacts with the heating body, and a pressurizing member that heat-pressurizes with the heating body through the film. The fixing part is a heating and pressurizing part that can be heat-fixed by passing a recording medium in which an unfixed image is formed between the film and the pressurizing member.

Heating in the heating and pressurizing part is preferably from 80° C. to 200° C., in general.

The surface pressure in the heating and pressurizing part is not particularly limited and can be appropriately selected according to the purpose. The surface pressure is preferably in a range from 10 N/cm² to 80 N/cm².

In the present embodiment, for example, a known optical fixing device may be used along with or instead of the fixing part according to the purpose.

(Others)

The image forming apparatus according to one embodiment may be provided with other parts, such as a static eliminating part, a recycling part, a control part, and the like.

((Static Eliminating Part))

The static eliminating part is not particularly limited, and only if a static elimination bias can be applied to the electrostatic latent image bearer, the static eliminating part can be suitably selected from known static eliminating devices, and for example, a static elimination lamp and the like can be suitably used.

((Cleaning Part))

The cleaning part can remove the toner remaining on the electrostatic latent image bearer, and the cleaning part can be selected appropriately from among known cleaners. Examples of the cleaning parts include a magnetic brush cleaner, an electrostatic brush cleaner, a magnetic roller cleaner, a blade cleaner, a brush cleaner, a web cleaner, and the like.

The image forming apparatus according to one embodiment can improve cleanability by having the cleaning part. That is, by controlling the adhesive force between the toners, the fluidity of the toner is maintained and the cleanability can be improved. In addition, by controlling the characteristics of the toner after deterioration, excellent cleaning quality can be maintained even under severe conditions such as long service life, and high temperature, and humidity. Furthermore, the external additive agent can be sufficiently freed from the toner on the photoconductor. Therefore, high cleanability can be achieved by forming a deposit layer (dam layer) of the external additive agent at the cleaning blade nip part.

((Recycling Part))

The recycling part is not particularly limited, but includes known transport means.

((Controlling Part))

The controlling part can control the movement of the above parts. As for the controlling part, if the movement of the above parts can be controlled, the controlling part is not particularly limited, and can be selected appropriately according to the purpose. For example, controlling devices such as sequencers and computers can be used.

The image forming apparatus of one embodiment can form images using the toner of one embodiment. Therefore, the toner having high weather resistance and having excellent environmental responsiveness, low-temperature fixability, and heat-resistant storage stability can be provided, stably obtaining high-quality images for a long period of time.

<Method of Forming Images>

The method of forming images according to one embodiment includes an electrostatic latent image forming step of forming an electrostatic latent image on an electrostatic latent image bearer and a developing step of developing the electrostatic latent image using the toner to form a toner image, and may include other steps as needed. The method of forming images can be suitably performed by the image forming apparatus, the electrostatic latent image forming step can be suitably performed by the electrostatic latent image forming part, the developing step can be suitably performed by the developing part, and the other steps can be suitably performed by the other parts.

In addition, the method of forming images according to one embodiment more preferably includes a transfer step of transferring the toner image onto a recording medium and a fixing step of fixing the transferred image onto the surface of the recording medium, in addition to the above electrostatic latent image forming step and developing step.

In the developing step, the toner according to one embodiment is used. Preferably, a toner image may be formed by using a developer containing the toner of one embodiment and, if necessary, other components such as carriers.

The electrostatic latent image forming step is a step of forming an electrostatic latent image on an electrostatic latent image bearer and includes a charging step of charging the surface of the electrostatic latent image bearer and an exposure step of exposing the surface of the charged electrostatic latent image bearer to form an electrostatic latent image. Chargeability can be performed, for example, by applying a voltage to the surface of the electrostatic latent image bearer using a charger. Exposure can be performed, for example, by image-like exposure of the surface of the electrostatic latent image bearer using the exposure device. The formation of the electrostatic latent image can be performed by, for example, uniformly charging the surface of the electrostatic latent image bearer, followed by exposing as image-like exposure by the electrostatic latent image forming part.

The developing step is a step of forming a visible image by sequentially developing an electrostatic latent image with a multi-color toner. The formation of the visible image can be carried out, for example, by developing the electrostatic latent image using the toner by the developing device.

In the developing device, for example, the toner and the carrier are mixed and stirred, and the toner is charged by friction at that time, and is held on the surface of the rotating magnet roller in the form of brush. The magnet roller is located near the electrostatic latent image bearer (photoconductor), a part of the toner constituting the magnetic brush formed on the surface of the magnet roller moves to the surface of the electrostatic latent image bearer (photoconductor) by the electric attraction force. As a result, the electrostatic latent image is developed by the toner to form a visible image by the toner on the surface of the electrostatic latent image bearer (photoconductor).

The transfer step is the step of transferring a visible image onto a recording medium. The transfer step is preferably performed using an intermediate transfer body, and after primary transfer of the visible image onto the intermediate transfer body, a secondary transfer of the visible image onto the recording medium is performed.

The transfer step is more preferably performed using two or more toners, preferably full color toners, and includes a first transfer step in which the visible image is transferred onto the intermediate transfer body to form a composite transfer image, and a second transfer step in which the composite transfer image is transferred onto the recording medium. If the image to be secondarily transferred onto the recording medium is a color image consisting of toners of multiple colors, the transfer step may use an intermediate transfer medium to form an image on the intermediate transfer medium by sequentially overlaying toners of each color on the intermediate transfer medium, and then transfer the image on the intermediate transfer medium by the intermediate transfer medium to the recording medium in a batch for secondary transfer.

Transfer can be performed, for example, by charging the electrostatic latent image bearer (photoconductor) with a transfer charger for the visible image by a transferring part.

The fixing step is a step of fixing the visible image transferred onto the recording medium by using a fixing device, and may be performed for each color developer every time the image is transferred onto the recording medium, or simultaneously for each color developer in a laminated state.

The method of forming images according to one embodiment may further include other steps selected as appropriate, such as a static elimination step, a cleaning step, a recycling step, and the like.

The static elimination step is a step of applying a static elimination bias to the electrostatic latent image bearer to eliminate static electricity, and can be preferably performed by the static eliminating part.

The cleaning step is a step of removing the toner remaining on the electrostatic latent image bearer, and can be performed more favorably by the cleaning part.

The recycling step is a step of having the developing part recycle the toner removed by the cleaning step, and can be performed more favorably by the recycling part.

Since the method of forming images according to one embodiment can perform image formation using the toner according to one embodiment, the toner having high weather resistance and having excellent environmental responsiveness, low-temperature fixability, and heat-resistant storage stability can be provided, stably obtaining high-quality images for a long period of time.

[One Embodiment of Image Forming Apparatus]

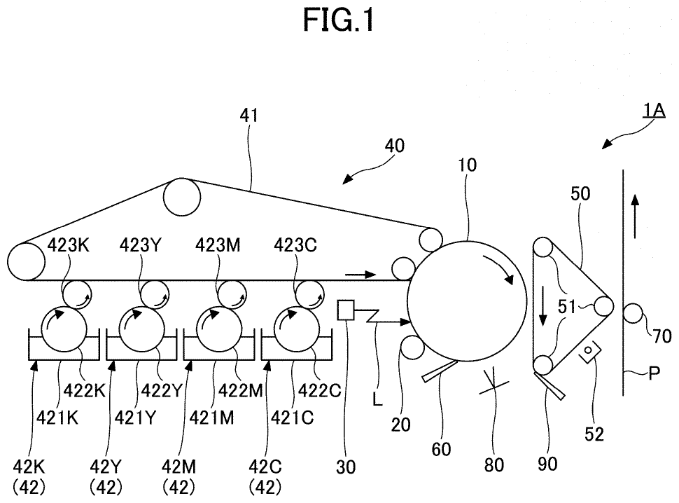

Next, one embodiment of the image forming apparatus according to one embodiment will be described with reference to FIG. 1. FIG. 1 is a schematic configuration diagram illustrating an example of an image forming apparatus according to an embodiment. As illustrated in FIG. 1, an image forming apparatus 100A is equipped with a photoconductor drum 10 which is an electrostatic latent image bearer, a charging roller 20 which is an charging part, an exposure device 30 which is an exposing part, a developing device 40 which is a developing part, an intermediate transfer body (intermediate transfer belt) 50, a cleaning device 60 which is a cleaning part, a transfer roller 70 which is a transferring part, a static elimination lamp 80 which is a static eliminating part, and an intermediate transfer body cleaning device 90.

The intermediate transfer body 50 is an endless belt stretched by three rollers 51 placed inside and designed to be movable in the direction, shown by arrow, by three rollers 51. Some of the three rollers 51 also function as transfer bias rollers capable of applying a predetermined transfer bias (primary transfer bias) to the intermediate transfer body 50. In the vicinity of the intermediate transfer body 50, the intermediate transfer body cleaning device 90 is placed. In the vicinity of the intermediate transfer body 50, the transfer roller 70 is placed opposite to the intermediate transfer body 50, and the transfer bias (secondary transfer bias) can be applied to transfer (secondary transfer) the developed image (toner image) to transfer (secondary transfer) a transfer paper P as a recording medium. Around the intermediate transfer body 50, a corona charger 52 for applying an electric charge to the toner image on the intermediate transfer body 50 is placed between a contact part between the photoconductor drum 10 and the intermediate transfer body 50 and the contact part between the intermediate transfer body 50 and the transfer paper P in the rotational direction of the intermediate transfer body 50.

The developing device 40 is configured by a developing belt 41 as a developer carrier and a developing unit 42 attached to the periphery of the developing belt 41.

The developing belt 41 is an endless belt stretched by a plurality of belt rollers and can be moved in the direction shown by the arrow in the figure. Furthermore, a part of the developing belt 41 is in contact with the photoconductor drum 10.

The developing unit 42 is configured by a black (Bk) developing unit 42K, a yellow (Y) developing unit 42Y, a magenta (M) developing unit 42M, and a cyan (C) developing unit 42C.

The black developing unit 42K includes a developer housing part 421K, a developer supply roller 422K, and a developing roller (developer carrier) 423K. The yellow developing unit 42Y includes a developer housing part 421Y, a developing supply roller 422Y, and a developing roller 423Y. The magenta developing unit 42M includes a developer housing part 421M, a developer supply roller 422M, and a developing roller 423M. The cyan developing unit 42C includes a developer housing part 421C, a developer supply roller 422C, and a developing roller 423C.

Next, a method of forming an image using the image forming apparatus 100A will be described. First, the surface of the photoconductor drum 10 is uniformly charged using the charged roller 20, and then expose an exposure light L to the photoreceptor drum 10 using the exposure device 30 to form an electrostatic latent image. Then, the electrostatic latent image formed on the photoconductor drum 10 is developed with the toner supplied from the developing device 40 to form a toner image. Furthermore, the toner image formed on the photoconductor drum 10 is transferred (primary transfer) onto the intermediate transfer body 50 by the transfer bias applied from the roller 51, and then transferred (secondary transfer) onto the transfer paper P supplied by a paper feed part (not shown) by the transfer bias applied from the transfer roller 70. On the other hand, the photoconductor drum 10, on which the toner image is transferred to the intermediate transfer body 50, is eliminated by the static elimination lamp 80 after the toner remaining on the surface is removed by the cleaning device 60. The residual toner on the intermediate transfer body 50 after image transfer is removed by the intermediate transfer body cleaning device 90.

After the transfer step is completed, the transfer paper P is transported to a fixing unit, in which the toner image transferred above is fixed on the transfer paper P.

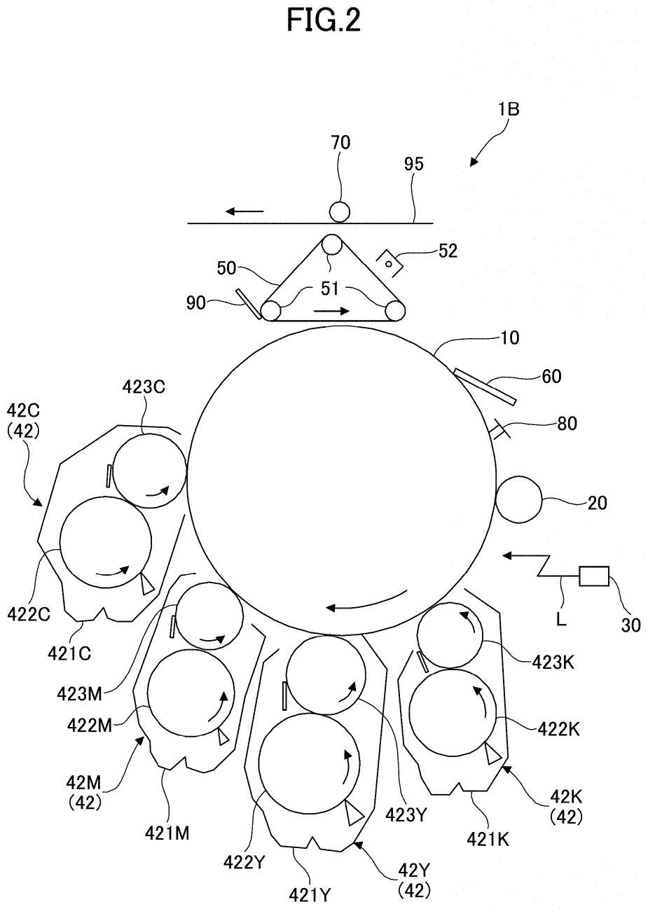

FIG. 2 is a schematic configuration diagram illustrating another example of an image forming apparatus according to one embodiment. As illustrated in FIG. 2, the image forming apparatus 100B has the same configuration as the image forming apparatus 100A in the image forming apparatus 100A illustrated in FIG. 1 except that the developing unit 42 (Black developing unit 42K, yellow developing unit 42Y, magenta developing unit 42M, and cyan developing unit 42C) is arranged directly facing each other around the photoconductor drum 10 without providing the developing belt 41.

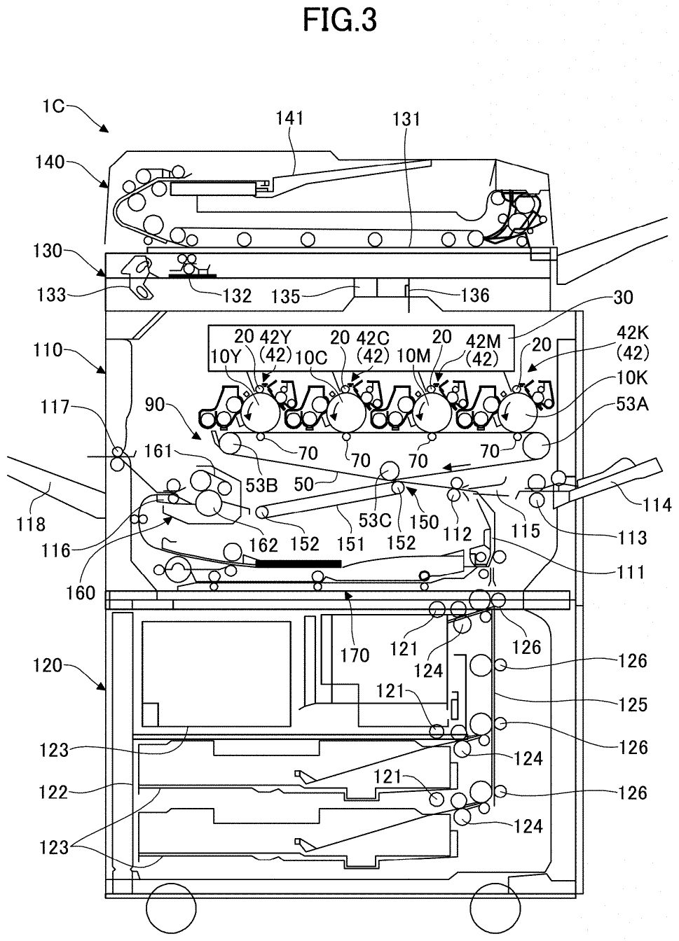

FIG. 3 is a schematic configuration diagram illustrating another example of an image forming apparatus according to one embodiment. As illustrated in FIG. 3, the image forming apparatus 100C is a tandem type color image forming apparatus and is equipped with a copying machine body 110, a paper feeding table 120, a scanner 130, an automatic document feeder (ADF) 140, a secondary transfer device 150, a fixing device 160 which is a fixing part, and a sheet reversing device 170.

An endless belt-shaped intermediate transfer body 50 is provided at the center of the copying machine body 110. The intermediate transfer body 50 is an endless belt stretched over three rollers 53A, 53B, and 53C and can move in the direction shown by the arrow in FIG. 3. In the vicinity of the roller 53B, the intermediate transfer body cleaning device 90 is placed to remove toner remaining on the intermediate transfer body 50 on which the toner image has been transferred to the recording paper. The developing unit 42 (Yellow (Y) developing unit 42Y, cyan (C) developing unit 42C, magenta (M) developing unit 42M, and black (Bk) developing unit 42K), which is a tandem type developing device, is placed opposite to and opposed with the intermediate transfer body 50 stretched by the rollers 53A and 53B along the conveyance direction.

The exposure device 30 is placed in the vicinity of the developing unit 42. Further, the secondary transfer device 150 is placed on the side opposite to the side where the developing unit 42 of the intermediate transfer body 50 is placed. The secondary transfer device 150 is equipped with a secondary transfer belt 151. The secondary transfer belt 151 is an endless belt stretched over a pair of rollers 152, and the recording paper conveyed on the secondary transfer belt 151 and the intermediate transfer body 50 can contact between the roller 53C and the roller 152.

In addition, the fixing device 160 is placed in the vicinity of the secondary transfer belt 151. The fixing device 160 is equipped with a fixing belt 161, which is an endless belt stretched over a pair of rollers, and a pressure roller 162, which is placed and pressed against the fixing belt 161.

In the vicinity of the secondary transfer belt 151 and the fixing device 160, a sheet reversing device 170 is placed to reverse the recording paper when an image is formed on both sides of the recording paper.

Next, a method of forming a full-color image using an image forming apparatus 100C will be described. First, a color document is set on a document stand 141 of the automatic document feeder (ADF) 140, or, the ADF 140 is opened, the color document is set on an exposure glass 131 of the scanner 130, and the ADF 140 is closed.

In a case where a color document is set in the automatic document feeder 140 and a start switch (not shown) is pressed, and the color document is transported and moved to the exposure glass 131 and moved onto the exposure glass. Then, the scanner 130 is driven, and a first running body 132 and a second running body 133 equipped with light sources are driven. On the other hand, when a document is set on the exposure glass 131, the scanner 130 is driven to run the first running body 132 and the second running body 133 equipped with the light sources. At this time, the color document (color image) is read and black, yellow, magenta, and cyan image information is obtained by reflecting the light from the document surface emitted from the first running body 132 by the mirror on the second running body 133 and then receiving the light at a reading sensor 136 through an imaging lens 135.

The image information of each color is transmitted to each color developing unit (yellow developing unit 42Y, cyan developing unit 42C, magenta developing unit 42M, and black developing unit 42K) to form a toner image of each color.

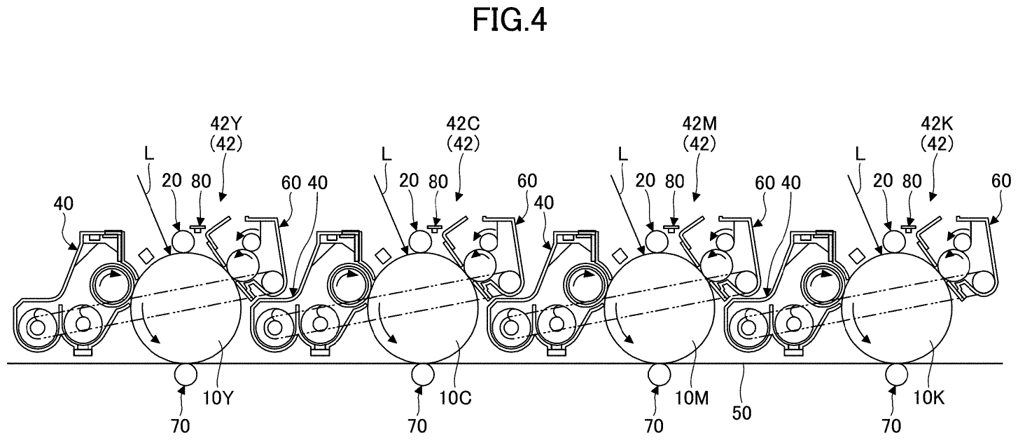

FIG. 4 is a partially enlarged view of the image forming apparatus of FIG. 3. As illustrated in FIG. 4, each developing unit (yellow developing unit 42Y, cyan developing unit 42C, magenta developing unit 42M, and black developing unit 42K) is equipped with a photoconductor drum 10 (photoconductor drum for black 10K, photoconductor drum for yellow 10Y, photoconductor drum for magenta 10M, and photoconductor drum for cyan 10C); a charged roller 20 which is a charging part for uniformly charging the photoconductor drum 10; the exposure device 30 which exposes an exposure light L on the photoconductor drum 10 based on image information of each color and forms an electrostatic latent image of each color on the photoconductor drum 10; the developing device 40 which is a developing part for developing an electrostatic latent image with a developer of each color and forming a toner image of each color; a transfer charger 62 for transferring a toner image onto the intermediate transfer body 50; the cleaning device 60; and the static elimination lamp 80.

Toner images of each color formed in each color developing unit (yellow developing unit 42Y, cyan developing unit 42C, magenta developing unit 42M, and black developing unit 42K) are sequentially transferred (primary transfer) onto the intermediate transfer body 50 that is stretched and moved by the rollers 53A, 53B, and 53C. Then, the toner images of each color are superimposed on the intermediate transfer body 50 to form a composite color image (color transfer image).

On the other hand, in the paper feed table 120, one of the paper feed rollers 121 is selectively rotated to feed the recording paper from one of the paper feed cassettes 123 provided in a paper bank 122 in multiple stages. The recording paper is separated one by one by separation rollers 124 and delivered to a paper feed path 125, conveyed by conveyance rollers 126, guided to a paper feed path 111 in a copying machine body 110, and stopped by abutting against a pair of resist roller 112. Alternatively, a manual feed roller 113 is rotated to feed out the recording paper on a manual feed tray 114, the paper is separated one by one by the manual feed roller 113, guided to a manual feed path 115, and stopped by abutting against the resist roller 112.

The resist roller 112 is generally used grounded, but may be used with a bias applied to remove paper dust from the recording paper.

Then, the resist roller 112 is rotated in timing with the composite color image (color transfer image) formed on the intermediate transfer body 50, the recording paper is sent out between the intermediate transfer body 50 and the secondary transfer belt 151, and the composite color image (color transfer image) is transferred (secondary transfer) onto the recording paper. Toner remaining on the intermediate transfer body 50 onto which the composite color image (color transfer image) has been transferred is removed by the intermediate transfer body cleaning device 90.

After the recording paper onto which the composite color image (color transfer image) has been transferred is conveyed by the secondary transfer belt 151, the composite color image (color transfer image) is fixed on the recording paper by the fixing device 160.

Then, the transfer path of the recording paper is switched by a switching pawl 116, and the recording paper is discharged onto a paper discharge tray 118 by a discharge roller 117. Alternatively, the transfer path of the recording paper is switched by the switching pawl 116, inverted by the sheet reversing device 170, guided again by the secondary transfer belt 151, an image is formed on the back of the recording paper in the similar manner, and then the recording paper is discharged by the discharge roller 117 onto the paper discharge tray 118.

<Process Cartridge>

The process cartridge according to one embodiment is formed detachably attached to various image forming apparatuses and has an electrostatic latent image bearer that carries an electrostatic latent image and a developing part that develops the electrostatic latent image bearer on the electrostatic latent image bearer with the developer according to one embodiment to form a toner image, and may have other configurations as needed.

Since the electrostatic latent image bearer is similar to the electrostatic latent image bearer of the image forming apparatus described above, details are omitted.

The developing part includes a developer housing container for storing the developer according to one embodiment and a developer carrier for carrying and transporting the developer stored in the developer housing container. The developing part may further have a regulating member or the like to regulate the thickness of the developer to be carried.

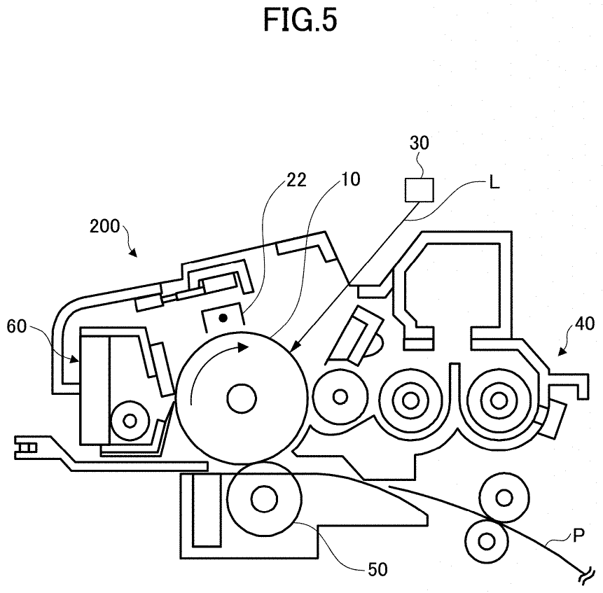

FIG. 5 illustrates an example of the process cartridge according to one embodiment. As illustrated in FIG. 5, an image forming apparatus process cartridge 200 includes the photoconductor drum 10, a corona charger 22 which is a charging part, the developing device 40, the cleaning device 60, and the transfer roller 70. In the figures, P indicates transfer paper and L indicates exposure light.

### EXAMPLES

Hereinafter, Examples and Comparative Examples are indicated to further illustrate the embodiments, but the embodiments are not limited by these Examples and Comparative Examples.

### Production Example B-1: Synthesis of Amorphous Polyester Resin B-1

Plant-derived propylene glycol, terephthalic acid, and plant-derived succinic acid were charged into a four-neck flask equipped with a nitrogen introduction tube, a dehydration tube, an agitator, and a thermocouple, so that the molar ratio of terephthalic acid to succinic acid (terephthalic acid/succinic acid) was 86/14 and the molar ratio of hydroxyl to carboxyl groups, OH/COOH, was to be 1.3. The prepared mixture was reacted with titanium tetraisopropoxide (500 ppm relative to the resin component) at atmospheric pressure for 8 hours at 230° C., followed by further reacting the mixture at a reduced pressure of 10 to 15 mmHg for 4 hours. Then, trimellitic anhydride was added to the reaction vessel at 1 mol % relative to the total resin component, and the mixture was reacted at 180° C. under atmospheric pressure for 3 hours to obtain an amorphous polyester resin B-1.

### Production Example B-2: Synthesis of Amorphous Polyester Resin B-2

Propylene glycol, bisphenol A propylene oxide 2 mol adduct, terephthalic acid, and plant-derived succinic acid were charged into a four-neck flask equipped with a nitrogen introduction tube, a dehydration tube, an agitator, and a thermocouple, so that the molar ratio of propylene glycol to bisphenol A ethylene oxide 2 mol adduct (propylene glycol/bisphenol A ethylene oxide 2 mol adduct) was 60/40, the molar ratio of terephthalic acid to succinic acid (terephthalic acid/succinic acid) was 86/14, and the molar ratio of hydroxyl group to carboxyl group, OH/COOH, was to be 1.3. The prepared mixture was reacted with titanium tetraisopropoxide (500 ppm relative to the resin component) at atmospheric pressure for 8 hours at 230° C., followed by further reacting the mixture at a reduced pressure of 10 to 15 mmHg for 4 hours. Then, trimellitic anhydride was added to the reaction vessel at 1 mol % relative to the total resin component, and the mixture was reacted at 180° C. under atmospheric pressure for 3 hours to obtain an amorphous polyester resin B-2.

### Production Example B-3: Synthesis of Amorphous Polyester Resin B-3

Bisphenol A ethylene oxide 2 mol adduct, bisphenol A propylene oxide 2 mol adduct, terephthalic acid, and plant-derived succinic acid were charged into a four-neck flask equipped with a nitrogen introduction tube, a dehydration tube, an agitator, and a thermocouple, so that the molar ratio of bisphenol A propylene oxide 2 mol adduct to bisphenol A ethylene oxide 2 mol adduct was 60/40 (bisphenol A propylene oxide 2 mol adduct/bisphenol A ethylene oxide 2 mol adduct), the molar ratio of terephthalic acid to succinic acid was 86/14 (terephthalic acid/succinic acid), and the molar ratio of hydroxyl group to carboxyl group, OH/COOH, was to be 1.3. The prepared mixture was reacted with titanium tetraisopropoxide (500 ppm relative to the resin component) at atmospheric pressure for 8 hours at 230° C., followed by further reacting the mixture at a reduced pressure of to 15 mmHg for 4 hours. Then, trimellitic anhydride was added to the reaction vessel at 1 mol % relative to the total resin component, and the mixture was reacted at 180° C. under atmospheric pressure for 3 hours to obtain an amorphous polyester resin B-3.

### Production C-1: Synthesis of Crystalline Polyester Resin C-1

Plant-derived sebacic acid and 1,6-hexanediol were charged into a 5 L four-neck flask equipped with a nitrogen introduction tube, a dehydrator tube, an agitato, and a thermocouple, so that the molar ratio of hydroxyl to carboxyl groups, OH/COOH, was to be 0.9. The prepared mixture was reacted with titanium tetraisopropoxide (500 ppm relative to the resin component) at 180° C. for 10 hours, followed by heating the mixture at 200° C. for 3 hours. Furthermore, the mixture was subjected to react at a pressure of 8.3 kPa for 2 hours to obtain a crystalline polyester resin C-1.

### Production Example C-2: Synthesis of Crystalline Polyester Resin C-2

A crystalline polyester resin C-2 was obtained in the same manner as the synthesis of crystalline polyester resin C-1, except that the diol was changed to plant-derived ethylene glycol.

### Production Example C-3: Synthesis of Crystalline Polyester Resin C-3

A crystalline polyester resin C-3 was obtained in the same manner as the synthesis of crystalline polyester resin C-1, except that the dicarboxylic acid was changed to adipic acid.

<Preparation of Crystalline Polyester Resin Dispersion Liquid 1>

45 parts by mass of the crystalline polyester resin C-1 and 450 parts by mass of ethyl acetate were charged into a container set with a stirring rod and a thermometer, and the temperature of the mixture was raised to 80° C. under stirring, kept at 80° C. for 5 hours, and then cooled to 30° C. in 1 hour. The mixture was then dispersed by using a bead mill (Ultra Visco Mill, manufactured by IMEX Co., Ltd.) under the conditions of feeding speed of 1 kg/hr, disk circumferential speed of 6 m/s, filling 80 vol. % of 0.5 mm diameter zirconia beads, and three passes to obtain a crystalline polyester resin dispersion liquid 1. The volume average particle size of the obtained crystalline polyester resin particles was 350 nm, and the concentration of solid content of the resin particles was 10%.

<Preparation of Crystalline Polyester Resin Dispersion Liquid 2>

45 parts by mass of the crystalline polyester resin C-2 and 450 parts by mass of ethyl acetate were charged into a container set with a stirring rod and a thermometer, and the temperature of the mixture was raised to 80° C. under stirring, kept at 80° C. for 5 hours, and then cooled to 30° C. in 1 hour. The mixture was then dispersed by using a bead mill (Ultra Visco Mill, manufactured by IMEX Co., Ltd.) under the conditions of feeding speed of 1 kg/hr, disk circumferential speed of 6 m/s, filling 80 vol. % of 0.5 mm diameter zirconia beads, and three passes to obtain a crystalline polyester resin dispersion liquid 2. The volume average particle size of the obtained crystalline polyester resin particles was 350 nm, and the concentration of solid content of the resin particles was 10%.

<Preparation of Crystalline Polyester Resin Dispersion Liquid 3>

45 parts by mass of the crystalline polyester resin C-3 and 450 parts by mass of ethyl acetate were charged into a container set with a stirring rod and a thermometer, and the temperature of the mixture was raised to 80° C. under stirring, kept at 80° C. for 5 hours, and then cooled to 30° C. in 1 hour. The mixture was then dispersed by using a bead mill (Ultra Visco Mill, manufactured by IMEX Co., Ltd.) under the conditions of feeding speed of 1 kg/hr, disk circumferential speed of 6 m/s, filling 80 vol. % of 0.5 mm diameter zirconia beads, and three passes to obtain a crystalline polyester resin dispersion liquid 3. The volume average particle size of the obtained crystalline polyester resin particles was 360 nm, and the concentration of solid content of the resin particles was 10%.

<Preparation of WAX Dispersion Liquid 1>

180 parts by mass (WE-11, Synthetic wax of plant-derived monomers, melting point 67° C., manufactured by NOF Corporation) of ester wax and 17 parts by mass (Neogen SC, sodium dodecylbenzene sulfonate, manufactured by Daiichi Kogyo Co., Ltd.) of anionic surfactant were added to 720 parts by mass of ion-exchanged water. The mixture was subjected to dispersion treatment with a homogenizer while being heated to 90° C. to obtain a WAX dispersion liquid 1. The volume average particle size of wax particles contained in the obtained WAX dispersion liquid 1 was 250 nm, and the concentration of solid content of the resin particles was 25%.

<Preparation of WAX Dispersion 2>

50 parts by mass (HNP-9, hydrocarbon wax, melting point 75° C., SP value 8.8, manufactured by NIPPON SEIRO CO., LTD.) of paraffin wax and 450 parts by mass of ethyl acetate were charged into a container set with a stirring rod and a thermometer, and the temperature of the mixture was raised to 80° C. under stirring, kept at 80° C. for 5 hours, and then cooled to 30° C. in 1 hour. The mixture was then dispersed by using a bead mill (Ultra Visco Mill, manufactured by IMEX Co., Ltd.) under the conditions of feeding speed of 1 kg/hr, disk circumferential speed of 6 m/s, filling 80 vol. % of 0.5 mm diameter zirconia beads, and three passes to obtain a WAX dispersion liquid 2. The volume average particle size of the WAX particles was 350 nm, and the concentration of solid content of the resin particles was 25%.

<Preparation of Master Batch (MB) 1>

1,200 parts by mass of water, 500 parts by mass of P.Y185 of an isoindoline pigment, and 500 parts by mass of the crystalline polyester resin B-1 were added and mixed in a Henschel mixer (manufactured by NIPPON COKE & ENGINEERING. CO., LTD), the mixture was kneaded for 30 minutes at 150° C. using two rolls, then rolled and cooled, followed by pulverizing by a pulverizer to obtain a master batch 1 (MB1).

<Preparation of Master Batch (MB)2>

A master batch 2 (MB2) was obtained in the same manner as in the preparation of master batch 1, except that the pigment was changed to P.Y74 which is not isoindoline pigment.

<P-1: Introduction of PET>

Flake-shaped recycled PET was mixed so as to be the solid content shown in Table 1 when mixing the materials in the synthesis of amorphous polyester resin described above.

<Preparation of Resin Particles>

### Example 1

<Oil Phase Preparation Step>

100 parts by mass of WAX dispersion liquid 2 (50 parts by mass of solid content), 100 parts by mass of crystalline polyester resin dispersion liquid 1 (25 parts by mass of solid content), 800 parts by mass of amorphous polyester resin B-3 (Of that amount, 80 parts by mass of PET is added to the mixture of raw materials), 12 parts by mass of MB1 and 38 parts by mass of MB2 were put into a container and mixed at 5,000 rpm for 60 minutes with a TK homomixer (manufactured by PRIMIX Corporation) to obtain an oil phase 1. The above formula indicates the amount of solid content in each raw material.

The content A of isoindoline pigment and the content B of PET are the amounts of solids in the oil phase preparation step. In the above case, the total number of parts to be charged is 925 parts by mass (WAX: 50 parts by mass, crystalline polyester: 25 parts by mass, amorphous polyester: 720 parts by mass, PET: 80 parts by mass, MB1: 12 parts by mass, MB2: 38 parts by mass), whereas 12 parts by mass of MB1 (6 parts by mass of pigment) makes 0.65 parts by mass of A and 80 parts by mass of B. Therefore, C is “(content of PET/number of parts to be charged)×100=80/925×100=8.65.”

<Preparation of Aqueous Phase>

A milky white liquid was obtained by mixing and stirring 990 parts by mass of water, 20 parts by mass of sodium dodecyl sulfate, and 90 parts by mass of ethyl acetate to prepare an aqueous phase 1.

<Emulsification>

20 parts by mass of 28% ammonia solution was added to 700 parts by mass of the oil phase 1 and mixed using a TK homomixer while stirring at 8,000 rpm, followed by mixing for 10 minutes, 1,200 parts by mass of aqueous phase 1 was gradually dropped to obtain an emulsified slurry 1.

<Desolvation Agent>

The emulsified slurry 1 was put into a container equipped with an agitator and a thermometer, and desolvated at 30° C. for 180 minutes to obtain a desolvated slurry 1.

<Agglomeration>

After adding 100 parts by mass of 3% magnesium chloride solution to the desolvated slurry 1 and agitating the mixture for another 5 minutes, the temperature was raised to 60° C. When the particle size became 5.0 μm, 50 parts by mass of sodium chloride was added to finish the agglomerating step to obtain an agglomerated slurry 1.

<Fusing>

The agglomerated slurry 1 was heated to 70° C. with stirring and cooled to the desired average circularity of 0.957 to obtain a dispersed slurry 1.

<Cleaning and Drying>

After 100 parts by mass of the dispersed slurry 1 was filtered under reduced pressure, the following procedures (1) to (4) were performed twice to obtain a filtered cake 1.
(1): 100 parts by mass of ion-exchanged water was added to the filtered cake, mixed with a TK homomixer (at 12,000 rpm for 10 minutes), and filtered.
(2): 100 parts by mass of a 10% sodium hydroxide aqueous solution was added to the filtered cake of (1), mixed with the TK homomixer (at 12,000 rpm for 30 minutes), and filtered under reduced pressure.
(3): 100 parts by mass of 10% hydrochloric acid was added to the filtered cake of (2), mixed with the TK homomixer (at 12,000 rpm for 10 minutes), and filtered.
(4): 300 parts by mass of ion-exchanged water was added to the filtered cake of (3), mixed with the TK homomixer (at 12,000 rpm for 10 minutes), and filtered.

The resulting filtered cake 1 was dried at 45° C. for 48 hours in a circulating air dryer and sieved with a mesh of 75 μm with the opening of the eyes to obtain a resin particle base 1.

<External Additive Treatment step>2.0 parts by mass of hydrophobic silica (HDK-2000, manufactured by Clariant Corporation) as an external additive was mixed with 100 parts by mass of the resin particle base 1 by a Henschel mixer, and the mixture was passed through a sieve with 500 mesh mesh opening to obtain resin particles 1.

The ¹⁴C concentration of the resin particles was 5.5 pMC, and (A/(B+C)) was 0.046.

[Examples 2 to 11 and Comparative Examples 1 to 3]

Resin particles 2 to 14 were produced in the same manner as the resin particles in Example 1, except that the types and amounts of WAX, crystalline resin, amorphous resin, PET, and MB in the agglomerating step were changed as described in Table 1.

TABLE 1

| | Materials | | | | | | | | | | | |
|---|---|---|---|---|---|---|---|---|---|---|---|---|
| | | | | | | MB2 | Additive parts (corresponding to solid content) | | | | | |
| | | | | | MB1 | (including | [Parts by mass] | | | | | |
| | | | Amorphous | Crystalline | (including | pigments | | | Amorphous | Crystalline | | |
| Resin | | | polyester | polyester | isoindoline | other than | | | polyester | polyester | | |
| particles | PET | WAX | resin | resin | pigment) | isoindoline ) | PET | WAX | resin | resin | MB1 | MB2 |
| 1 | P1 | W2 | B3 | C1 | Contained | Contained | 80 | 50 | 720 | 25 | 12 | 38 |
| 2 | P1 | W2 | B2 | C3 | Contained | Contained | 80 | 50 | 720 | 25 | 12 | 38 |
| 3 | P1 | W2 | B2 | C3 | Contained | Contained | 80 | 50 | 760 | 25 | 12 | 38 |
| 4 | P1 | W2 | B2 | C3 | Contained | Contained | 80 | 50 | 760 | 25 | 23 | 27 |
| 5 | P1 | W2 | B2 | C3 | Contained | Contained | 150 | 50 | 700 | 25 | 33 | 17 |
| 6 | P1 | W2 | B2 | C3 | Contained | Contained | 150 | 50 | 700 | 25 | 35 | 15 |
| 7 | P1 | W2 | B2 | C3 | Contained | Not contained | 180 | 50 | 700 | 25 | 50 | 0 |
| 8 | P1 | W2 | B2 | C3 | Contained | Not contained | 150 | 50 | 700 | 25 | 50 | 0 |
| 9 | P1 | W2 | B2 | C3 | Contained | Not contained | 350 | 50 | 400 | 25 | 50 | 0 |
| 10 | P1 | W1 | B1 | C2 | Contained | Not contained | 120 | 50 | 730 | 25 | 50 | 0 |
| 11 | P1 | W1 | B1 | C2 | Contained | Not contained | 120 | 100 | 500 | 170 | 50 | 0 |
| 12 | P1 | W2 | B3 | C3 | Contained | Not contained | 300 | 50 | 550 | 25 | 50 | 0 |
| 13 | P1 | W2 | B3 | C1 | Not contained | Contained | 80 | 50 | 720 | 25 | 0 | 50 |
| 14 | — | W1 | B1 | C2 | Contained | Not contained | 0 | 50 | 730 | 25 | 50 | 0 |

<Evaluation>

Each prepared resin particles 1 to 14 was used as a toner to evaluate its weather resistance, low-temperature fixability, and heat-resistant storage stability. The evaluation results are shown in Table 2.

[Weather Resistance]

The carrier used for imagio MP C5503 (manufactured by Ricoh Co., Ltd.) and the resin particles obtained above were mixed so that the concentration of the resin particles was to be 5% by mass, and a developer was obtained. After the developer was charged into the unit of imagio MP C5503 (manufactured by Ricoh Co., Ltd.), a solid image of a 2 cm×15 cm rectangle was formed on PPC paper type 6000 <70 W> A4 long grain paper (manufactured by Ricoh Co., Ltd.) so that the amount of toner deposited was to be 1.0 mg/cm². The formed image was irradiated with light for 100 minutes and sprayed with water for 20 minutes times using an atlas weatherometer Ci3000+(used light source: 6.5 kW xenon lamp), and the ΔE of the image before and after exposure was evaluated based on the following evaluation criteria.

### (Evaluation Criteria)

A: ΔE is less than 2.
B: ΔE is 2 or more and less than 3.
C: ΔE is 3 or more and less than 5.
D: ΔE is 5 and more.

[Low-Temperature Fixability]

The carrier used for imagio MP C5503 (manufactured by Ricoh Co., Ltd.) and the resin particles obtained above were mixed so that the concentration of the resin particles was 5% by mass, and a developer was obtained. After the developer was charged into the unit of imagio MP C5503 (manufactured by Ricoh Co., Ltd.), a solid image of a 2 cm×15 cm rectangle was formed on PPC paper type 6000<70 W> A4 long grain paper (manufactured by Ricoh Co., Ltd.) so that the amount of toner deposited was to be 0.40 mg/cm². At this time, the surface temperature of the fixing roller was changed, and it was observed whether cold offset occurred in which the developed image of the solid image was fixed at a place other than the desired place, and the low-temperature fixability was evaluated based on the following evaluation criteria.

### (Evaluation Criteria)

A: The temperature at which cold offset occurs is less than 110° C.
B: The temperature at which cold offset occurs is 110° C. or higher and less than 125° C.
C: The temperature at which cold offset occurs is 125° C. or higher.

[Heat-Resistant Storage Stability]

The toner was filled in a glass container of which evaluate heat-resistant storage stability, and left in a thermostatic bath at 50° C. for 24 hours. The toner was cooled to 24° C., and the degree of penetration was measured by a penetration test in accordance with JIS K 2235-1991, and the heat-resistant storage stability was evaluated based on the following evaluation criteria.

### (Evaluation Criteria)

A: Penetration is 25 mm or more.
B: Penetration is 10 mm or more and 25 mm or less.
C: Penetration is less than 10 mm.

[Overall Evaluation]

The overall rating was determined based on the following criteria. Those having all “A” among all evaluation items were determined as “A”, those having three or more “A” with the rest being “B” or “C” among evaluation items were determined as “B”, those having two “A” among the evaluation items with the rest being “B” or “C” among evaluation items were determined as “C”, and those having one or more “D” among the evaluation items were determined as “D”.

### (Evaluation Criteria)

A: Excellent
B: Good
C: Slightly better than conventional
D: Not practical

TABLE 2

| | | | | Evaluation results | | | | |
|---|---|---|---|---|---|---|---|---|
| | Characteristics | | | | | | Heat- | |
| | | ¹⁴C | | | | Low- | resistant | |
| | Resin | concentration | A/ | Environmental | Weather | temperature | storage | Overall |
| | particles | [pMC] | (B + C) | responsiveness | resistance | fixability | stability | evaluation |
| Example 1 | 1 | 5.5 | 0.046 | B | C | A | A | C |
| Example 2 | 2 | 14.8 | 0.028 | B | C | A | A | C |
| Example 3 | 3 | 15.1 | 0.027 | A | C | A | A | B |
| Example 4 | 4 | 15.2 | 0.051 | A | B | A | A | B |
| Example 5 | 5 | 13.8 | 0.058 | A | B | A | A | B |
| Example 6 | 6 | 13.8 | 0.062 | A | A | A | A | A |
| Example 7 | 7 | 13.8 | 0.078 | A | A | A | A | A |
| Example 8 | 8 | 13.8 | 0.088 | A | A | A | A | A |
| Example 9 | 9 | 9.2 | 0.058 | A | B | A | A | B |
| Example 10 | 10 | 32.5 | 0.057 | A | B | A | A | B |
| Example 11 | 11 | 49.0 | 0.043 | A | B | A | A | B |
| Comparative | 12 | 3.2 | 0.075 | A | D | C | A | D |
| Example 1 | | | | | | | | |
| Comparative | 13 | 5.5 | 0.000 | A | D | A | A | D |
| Example 2 | | | | | | | | |
| Comparative | 14 | 35.0 | 0.084 | A | D | A | C | D |
| Example 3 | | | | | | | | |

From Table 2, it was confirmed that the resin particles in Examples 1 to 11 were toner that satisfied all of the conditions for use in terms of environmental responsiveness, weather resistance, low-temperature fixability, and heat-resistant storage stability. On the other hand, the resin particles obtained in Comparative Examples 1 to 3 were toner that at least did not satisfy the conditions for use in terms of weather resistance, and it was confirmed that the toners in Comparative Examples were not practical.

Therefore, unlike the resin particles of Comparative Examples 1 to 3, the resin particles of Examples 1 to 11 in which PET is contained in the binder resin, isoindoline pigment is contained in the colorant, and the radioisotope ¹⁴C concentration in the resin particles is 5.4 pMC or higher, can provide high-quality toners with excellent environmental responsiveness, weather resistance, low-temperature fixability, and heat-resistant storage stability.

As described above, the above embodiment is presented as an example, and the present invention is not limited by the above embodiment. The above embodiment can be carried out in various other forms, and various combinations, omissions, replacements, modifications, and the like can be made without departing from the gist of the invention. These embodiments and their variations are included in the scope and abstract of the invention as well as in the equal scope of the invention described in the claims.

The embodiment of the invention is, for example, as follows.
<1> Resin particles include a binder resin and a colorant, wherein the binder resin contains polyethylene terephthalate and a plant-derived resin, wherein the colorant contains an isoindoline pigment, and wherein a radioisotope ¹⁴C concentration in the resin particles is 5.4 pMC or higher.
<2> The resin particles according to <1>, wherein the radioisotope ¹⁴C concentration of the resin particles is 10 pMC or higher and 70 pMC or lower.
<3> The resin particles according to <1> or <2>, wherein (A/(B+C)) is 1/20 or more when a content of the isoindoline pigment is A, the radioisotope ¹⁴C concentration of the resin particles is B, and a content of the polyethylene terephthalate is C.
<4> The resin particles according to <3>, wherein the (A/(B+C)) is 1/15 or more.
<5> A toner composed of the resin particles of any one of <1> to <4>.
<6> A developer containing the toner of <5> and a carrier.
<7> A toner housing unit containing the toner of <5>.
<8> An image forming apparatus includes an electrostatic latent image bearer; an electrostatic latent image forming part that forms an electrostatic latent image on the electrostatic latent image bearer; a developing part that develops the electrostatic latent image using a toner to form a visible image; a transferring part that transfers the visible image onto a recording medium; and a fixing part that fixes the transferred image onto the recording medium, wherein the toner is the toner of <5>.
<9> A method of forming images includes an electrostatic latent image forming step that forms an electrostatic latent image on an electrostatic latent image bearer; a developing step that develops the electrostatic latent image using a toner to form a visible image; a transfer step that transfers the visible image onto a recording medium; and a fixing step that fixes a transferred image onto the recording medium, wherein the toner is the toner of <5>.

What is claimed is:

1. Resin particles comprising:
a binder resin and a colorant,
wherein the binder resin contains polyethylene terephthalate and a plant-derived resin,
wherein the colorant contains an isoindoline pigment, and
wherein a radioisotope ¹⁴C concentration in the resin particles is 5.4 pMC or higher.

2. The resin particles according to claim 1, wherein the radioisotope ¹⁴C concentration of the resin particles is 10 pMC or higher and 70 pMC or lower.

3. The resin particles according to claim 1, wherein (A/(B+C)) is 1/20 or more when a content of the isoindoline pigment is A, the radioisotope ¹⁴C concentration of the resin particles is B, and a content of the polyethylene terephthalate is C.

4. The resin particles according to claim 3, wherein the (A/(B+C)) is 1/15 or more.

5. A toner composed of the resin particles of claim 1.

6. A developer containing the toner of claim 5 and a carrier.

7. A toner housing unit containing the toner of claim 5.

8. An image forming apparatus comprising:
an electrostatic latent image bearer;
an electrostatic latent image forming part that forms an electrostatic latent image on the electrostatic latent image bearer;
a developing part that develops the electrostatic latent image using a toner to form a visible image;
a transferring part that transfers the visible image onto a recording medium; and
a fixing part that fixes the transferred image onto the recording medium,
wherein the toner is the toner of claim 5.

9. A method of forming images comprising:
an electrostatic latent image forming step that forms an electrostatic latent image on an electrostatic latent image bearer;
a developing step that develops the electrostatic latent image using a toner to form a visible image;
a transfer step that transfers the visible image onto a recording medium; and
a fixing step that fixes a transferred image onto the recording medium,
wherein the toner is the toner of claim 5.
